(19) United States
(12) Patent Application Publication
(10) Pub. No.: US 2025/0153438 A1
(43) Pub. Date: May 15, 2025

(54) METHOD FOR SEPARATING POLYMER ELEMENTS, WHICH WERE PRODUCED BY AN ADDITIVE MANUFACTURING METHOD, BY MEANS OF GRANULAR MEDIA

(71) Applicant: 84J GMBH & CO. KG, Bad Koetzling (DE)

(72) Inventor: Jakob NEUHAEUSER, Inning (DE)

(21) Appl. No.: 18/698,555

(22) PCT Filed: Oct. 4, 2022
(86) PCT No.: PCT/EP2022/077601

§ 371 Date: Apr. 4, 2024

(30) Foreign Application Priority Data
Oct. 4, 2021 (DE) 10 2021 125 715.8
Nov. 10, 2021 (DE) 10 2021 129 284.0
Jun. 30, 2022 (DE) 10 2022 116 364.4

(51) Int. Cl. B29C 64/30; B24B 31/00; B29C 71/00; B33Y 40/20

(52) U.S. Cl. CPC B29C 64/30; B24B 31/00; B29C 71/0009; B33Y 40/20

(57) ABSTRACT

The present invention relates to a method for treating polymer elements obtained by an additive manufacturing process. The method encompasses providing a treating liquid in a chamber of an apparatus and providing the polymer elements to be treated. Further, the method optionally encompasses a heating step of heating a treating liquid to a temperature below an upper threshold temperature, wherein the upper threshold temperature is in a range of 1° C. to 80° C. below the melting temperature of the polymer from which the polymer elements are formed. The method further encompasses a treatment, preferably smoothing, step, wherein the polymer elements are in, or come into, contact with the treating liquid at a temperature above a lower threshold temperature and below the upper threshold temperature for a predetermined period. This is carried out under conditions in which the treating liquid is in liquid state. Furthermore, the method optionally encompasses a cooling step for cooling the polymer elements. The present invention also relates to an apparatus for treating polymer elements.

### CROSS-REFERENCE TO RELATED APPLICATIONS

This application is a U.S. national stage entry of international application no. PCT/EP2022/077601 filed on Oct. 4, 2022, and claims priority to and the benefit of German application no. DE 10 2021 129 284.0 filed on Nov. 20, 2021 and German application no. DE 10 2022 116 354.4 filed on Jun. 30, 2022, the entire contents of which are incorporated by reference herein.

### FIELD OF THE INVENTION

The present invention relates to a method for the preferred treatment of polymer elements, in particular as bulk material, which have been obtained by an additive manufacturing process and furthermore to an apparatus for the treatment of polymer elements. The present invention further relates to a control device or a closed-loop control device.

### BACKGROUND OF THE INVENTION

Additive processes, also called three-dimensional (3D) printing processes, are available in different forms starting from building materials in liquid, viscous, solid or powder form, such as for example selective laser sintering (SLS), multi-jet fusion (MJF), high speed sintering (HSS), fused deposition modeling (FDM) or fused filament fabrication (FFF).

Materials often used in additive manufacturing processes are, for example, thermoplastic polymers such as polyamide or thermoplastic elastomers such as among others thermoplastic polyurethane (TPU), thermoplastic polyamides (TPA), thermoplastic copolyester compounds (TPC).

These polymers often have an undesirable rough surface with a roughness height of up to 20 μm and more.

### SUMMARY OF THE INVENTION

The object of the present invention is to propose a method for increasing the surface smoothness of elements obtained by additive manufacturing processes.

Furthermore, an apparatus for treating polymer elements is to be specified.

The object according to the present invention is achieved by a method with the features as described herein and by an apparatus with the features as described herein.

A method for treating polymer elements obtained by an additive manufacturing process is thus proposed by the present invention. The method encompasses providing a treating liquid in a chamber of an apparatus and providing the polymer elements to be treated. The method further encompasses an optional heating step for heating a treating liquid, preferably to a temperature below an upper threshold temperature, wherein the upper threshold temperature is preferably in a range of 1° C. to 150° C. below the melting temperature of the polymer from which the polymer elements are formed. The method further encompasses a treatment step, preferably a smoothing step, wherein the polymer elements are in, or come into, contact with the treating liquid, preferably at a temperature above a lower threshold temperature and/or preferably below the upper threshold temperature, for an, e.g. predetermined, period. This preferably takes place under conditions in which the treating liquid is, at least initially, in liquid state. Furthermore, the method optionally encompasses a cooling step for cooling the polymer elements.

According to the present invention, polymer elements preferably obtained in an additive manufacturing process, such as selective laser sintering (SLS), multi-jet fusion (MJF), high speed sintering (HSS), fused deposition modeling (FDM), fused filament fabrication (FFF) or a binder jetting process, may be treated. Elements obtained with DLP, SLA and MJM processes as well as elements produced with other additive manufacturing processes may also be treated with the method of the present invention.

An apparatus for treating polymer elements obtained by an additive manufacturing process is further proposed by the present invention. The apparatus comprises a chamber with a cover, at least one container for receiving the polymer elements and the treating liquid and devices for controlling the temperature. The apparatus further preferably comprises at least one of the following devices: a circulation device, a heating device and/or a coolant tank with a cooling fluid.

The container may comprise an inner container, in particular for receiving the polymer elements.

The present invention further relates to a control device or closed-loop control device programmed in order to allow the execution or initiation of the method according to the present invention in any embodiment disclosed herein, for instance, through control commands to the components and/or actuators required for this purpose, in particular as disclosed herein. The control device may for this purpose be in signal communication with the required components, or may be prepared therefor.

The present invention further relates to elements as disclosed herein, obtained by the method according to the present invention.

Embodiments according to the present invention may comprise some, several or all of the features in any combination unless the person skilled in the art considers the particular combination to be technically impossible.

Advantageous developments of the present invention are each subject-matter of the embodiments.

In all of the following statements, the use of the expression “may be” or “may have” and so on, is to be understood synonymously with “preferably is” or “preferably has,” and so on respectively, and is intended to illustrate embodiments according to the present invention.

Whenever numerical words are mentioned herein, the person skilled in the art shall recognize or understand them as indications of numerical lower limits. Hence, unless this leads to a contradiction evident for the person skilled in the art, the person skilled in the art shall comprehend for example “one” (or “a/an”) as encompassing “at least one”. This understanding is also equally encompassed by the present invention as the interpretation that a numerical word, for example, “one” (or “a/an”) may alternatively mean “exactly one”, wherever this is evidently technically possible in the view of the person skilled in the art. Both of these understandings are encompassed by the present invention and apply herein to all used numerical words.

The person skilled in the art shall understand spatial information like e.g. “top”, “bottom”, “left” or “right”, whenever they are mentioned herein, as a spatial indication with reference to the alignment in the figures appended hereto and/or during use. “Bottom” is closer to the geocenter or to the lower edge of the figure than “top”.

Whenever an embodiment is mentioned herein, it represents an exemplary embodiment according to the present invention.

When it is disclosed herein that the subject-matter according to the present invention comprises one or several features in a certain embodiment, it is also respectively disclosed herein that the subject-matter according to the present invention does, in other embodiments, likewise according to the present invention, explicitly not comprise this or these features, for example, in the sense of a disclaimer. Therefore, for every embodiment mentioned herein it applies that the converse embodiment, e.g. formulated as negation, is also disclosed.

If method steps are mentioned herein, then the apparatus according to the present invention or the control device according to the present invention is in several embodiments configured in order to execute, in any combination, one, several or all of these method steps, in particular when these are automatically executable steps, or in order to accordingly control corresponding apparatuses which preferably correspond with their names to the designation of the respective method step (for example, “determining” as a method step and “apparatus for determining” for the apparatus, etc.) and which may likewise be part of the apparatus(es) or device(s) according to the present invention or may be connected thereto in signal communication.

When programmed or configured is mentioned herein, these terms are interchangeable in some embodiments.

When a signal communication or communication connection between two components is mentioned herein, this may be understood to mean a connection that exits during use. It may also be understood that a preparation for such a (wired, wireless or otherwise implemented) signal communication exists, for example by coupling both components, for example by pairing, etc.

Pairing is a process that takes place in connection with computer networks in order to establish an initial link between computer units for the purpose of communication. The best-known example of this is the establishing of a Bluetooth connection, by which various devices (e.g. smartphone, headphones) are connected to each other. Pairing is sometimes also referred to as bonding.

The control device or closed-loop control device of the apparatus according to the present invention may be programmed to automatically effect or initiate single, some or all of the method steps disclosed herein.

The terms “additive manufacturing, additive fabrication, additive manufacturing processes” as used in the present application encompass various processes in which polymer material, in particular polymer powder, is processed into three-dimensional objects under computer control.

They encompass sintering as well as a Binder Jetting method or FFF method.

They encompass methods in which a polymer powder is first melted, fused, sintered or bonded and then solidified at predetermined points. It is therefore a process in which a solid element is built layer by layer from building materials such as thermoplastic elastomers or polyamides. They also include light-induced processes such as SLA, DLP and MJM.

In particular, the term “additive manufacturing” as used in the present application encompasses a process in which a polymer powder is solidified into a predetermined shape or pattern in order to build an object or element, i.e., a component.

The term “powder-based additive manufacturing” as used in the present application refers to additive manufacturing processes that use polymers in powder form as a building material.

The term “element” as used in the present application refers to a product achieved by additive manufacturing. Alternatively, the term “component” finds the same or the identical meaning.

An element may be made from or with any usable polymer or may consist thereof, in particular in particular from a polyamide-based polymer or copolymer.

The term “polymer” as used in the present application encompasses polymers achieved from one type of monomer or from two or more types of monomers. It encompasses homopolymers, copolymers, block polymers, and mixtures of different types of polymers, in particular those mentioned herein.

The term “polyamide element” as used in the present application refers to an element achieved by an additive manufacturing process using polyamide or a polyamide-containing material as building material.

The term “polyamide” as used in the present application encompasses a type of polyamide, a mixture of two or more types of polyamide, polyamide copolymers such as PA6/PPO, and polyamide blends. It also encompasses polymers known as “nylon”.

The term “polyamide powder” as used in the present application encompasses a type of polyamide powder or a powder mixture of two or more types of polyamides as well as polyamide blends, i.e. blends of one or more polyamide powders with other powders, such as other polymer powders, metal powders, ceramic powders, fibers, etc.

The term “thermoplastic polymer” as used in the present application encompasses thermoplastic elastomers such as thermoplastic polyurethane (TPU), thermoplastic polyamides (TPA), thermoplastic polyetheramides such as PEBA, among others.

The term thermoplastic polymers encompasses also polymers such as polyamide, ABS and PEI. In particular, the term encompasses those thermoplastic polymers or elastomers that are suitable for powder-based additive manufacturing processes.

The term “thermoplastic polymer powder” as used in the present application encompasses one or more types of powders of thermoplastic polymers, such as, for example, a powder of one type of such polymer or a powder mixture of two or more types of thermoplastic polymer powders as polymer blends, i.e., blends of one or more thermoplastic polymer powders with other powders, such as other polymer powders, metal powders, ceramic powders, fibers, etc.

A “lower threshold temperature”, as used in the present application, is a temperature which when exceeded results in a treatment, functionalization or smoothing of the element and/or to a preferably permanent change in the surface or surface texture, respectively.

The treatment, in particular smoothing, may start slowly but recognizably at approximately the lower threshold temperature when an element is treated with a treating liquid above the lower threshold temperature, for example, from a duration of 10 seconds. This time period may thus be used to determine the lower threshold temperature.

The lower threshold temperature may depend on the polymer of the element, the size and shape of the element, the treating liquid and the pressure in the process chamber.

An “upper threshold temperature” as used in the present application is a temperature beyond which the element or its geometry (in particular its computer targeted geometry) is at least partially distorted or destroyed; it preferably depends on the specific treating liquid, the polymer and its melting temperature.

The upper threshold temperature is below the melting point or melting range of the polymer.

The lower and upper threshold temperatures may be determined as shown below.

A threshold temperature as mentioned herein may be measured both statically, i.e. in an at least largely stationary state of the elements and the treating agent, and dynamically, i.e. with at least moving treating agent and/or moving elements (and possibly moving granular media), whereby different temperature values may be measured between static and dynamic threshold temperatures (applies to lower and upper threshold temperatures), such as for example with differences of approximately 1° C., 2° C., 5° C. up to approximately 10° C., or for example when measuring a dynamic threshold temperature with additional moving granular media of over 10° C., such as for example approximately 15° C. or even over 20° C. temperature difference. Disclosures on threshold temperatures may, therefore, refer to both the static variant and, alternatively, the dynamic variant.

If a temperature is specified for application of a liquid or treatment with a liquid, the temperature preferably refers to the temperature of this liquid.

Applying a “liquid at x° C.” means that the liquid has a temperature of x° C. and/or at least x° C. when applied, and preferably further means that the temperature of the liquid is maintained for the specified period, for example, by heating devices such as a heating bath.

The smoothing temperature referred to herein is thus preferably the temperature of the treating liquid in the smoothing step b) disclosed herein.

The terms “room temperature” or “ambient temperature” as used in the present application refer to a temperature of 20° C.

When the term “applying” or “application” is used with regard to treatment with a treating liquid as described herein, this means that the treating liquid is applied on the element or the element is introduced into the treating liquid so that the element is completely or partially wetted or brought in contact with the treating liquid.

This may be achieved by devices known to the skilled person, for example by evaporating and/or immersing the elements in the treating liquid, such that the elements are, for example, completely surrounded by the treating liquid, or that selected parts of the elements are wetted by the treating liquid.

It is preferred that the treating liquid contacts the entire surface of an element and can also flow into channels, holes etc. or, if intended, cover at least selected sections of the surface of the element.

A period for applying the treating liquid is the period during which the treating liquid is in contact with the element at the predetermined temperature (or smoothing temperature) or until the treating liquid and the element(s) are separated from each other.

Time periods for heating and smoothing are those time periods during which the heating liquid or treating liquid, respectively, has the specified temperature and is in contact with the element.

The term “treating liquid” as used in the present application refers to a liquid mixture, for example comprising water and at least one alcohol, e.g. a monohydric or polyhydric, e.g. aliphatic, alcohol, for treating at least one element.

In some embodiments, the term “elements” encompasses polymer elements and vice versa.

In some embodiments, the terms “treating agent”, “treating medium” and “treating liquid” are interchangeable, in others they are not.

The term “water” includes amongst others tap water, distilled water, demineralized water, or a mixture thereof.

When reference is made herein to smoothing, e.g., a smoothing temperature, a smoothing step b), smoothing substeps, etc., this relates to a preferred embodiment of the present invention. The present invention also encompasses functionalizing or treating the elements or their surface. Thus, wherever smoothing, a smoothing temperature, a smoothing step b), smoothing substeps, etc. are mentioned, a functionalization, a functionalization temperature, a functionalization step b), functionalization substeps, a treatment, a treatment temperature, a treatment step b), treatment substeps, etc. are also disclosed. The foregoing terms are thus herein interchangeable and relate to alternative embodiments of the present invention. Consequently, in particular, the smoothing step b) may be a functionalization step b) or a treatment step b).

However, when deviating therefrom a distinction must be made between the treating agent and the functionalizing agent. They are to be understood herein as two different agents which may be used complementarily, not interchangeably.

In some embodiments, the treatment liquid is one of the following: tert-butanol, 3-Methyl-1-butanol, n-butanal, isobutanal, 1-octanol, 2-cctanol, 3-octanol, 4-octanol, pyran, 4-Methyltetrahydropyran, Tetrahydro-2-isobutyl-4-methylpyran-4-ol, rose oxide, isoprenol, 3-methyl-1,3-butanediol, 3-methyl-1,3-butanediol acetate, 2-methyl-1,3-pentanediol, 3-methyl-1,5-pentanediol, 3-Methoxy-3-methyl-1-butanol, 3-methyl-1-butanol, 3-methoxy-3-methylbutyl acetate, benzyl formate, benzyl acetate, butyl acetate, amyl acetate, 1-pentanol, 1-methoxy-2-propanol, 2-methoxy-1-propanol, 1,6-hexanediol, oxepan, 1,6-diaminohexane, ketals, 3-methoxy-1-butyl acetate, n-butyl glycolate, dibutoxymethane, methoxyphenols, methyl isobutyl ketone, cycloalkanes, isopropylidene glycerol, dimethyl carbonate, glycerol formal, 3-1.2 methyl-3-octanol, dibasic esters (DBE), isopropyl tetradecanoate, propylene glycol n-butyl ether, triethylene glycol monoethyl ether, triethylene glycol monomethyl ether, dimethyl hexane diate, dimethyl glutarate, 1,6-anhydro-3,4-dideoxy-β-D-glycero-hexanopyranos-2-ulose, dimethyl succinate, 2,5-dimethyl isosorbide, dihydrolevoglucosenone, ethylene glycol dimethyl ether, dihydrolevoglucosenone/2-methyltetrahydrofuran blend, 2-methyltetrahydrofuran, dihydrolevoglucosenone/γ-valerolactone blend, γ-valerolactone, 2-hydroxypropanoic acid ethyl ester, cyclopentyl methyl ether, heptane, 1-Methoxy-2-propyl acetate, glycol ether, tripropylene glycol monomethyl ether, dipropylene glycol methyl ether, dipropylene glycol methyl ether acetate, dipropylene glycol dimethyl ether, diacetone alcohol, butyl glycol acetate, butyl diglycol acetate, diisobuytl ester, dimethyl ester, ISO paraffins, butylhydroxytoluene, ethoxylated alcohols, C9-11 alcohols, C9-11 pareth-6, C12-15 pareth 7, n-alkanes, iso-alkanes, solvents based on modified alcohols, alkoxy-propanols, DOWCLENE™* 16 Series Modified Alcohol, SENSENE™ Solvent (mixture of modified alcohol and hydrocarbons, C11-C13, isoalkanes, <2% aromatics), paraffin, petroleum, dimethyl-2-methylglutarate, propyl glycol, neopentyl glycol, tripropylene glycol, 2,2-dimethyl-4-hydroxymethyl-1,3-dioxolane, carboxylic acid ester, acrylic acid ester, 1,6-Hexanediol diacrylate, hexamethylene diacrylate, adipoyl dichloride, hexamethylene diamine, triethanolamine, ethyl-3-ethoxypropionate, diethylhexyl adipate, alkyl polyglycosides or suitable mixtures or solutions thereof.

In several embodiments, the treating agent is one, or a mixture, of the following solvents:
un-substituted, monosubstituted, and polysubstituted alcohols (for example, methanol, ethanol, isopropanol, 1-propanol, tert-butanol, 1-pentanol, isoprenol, neopentyl glycol, 3-methyl-1-butanol, 3-methyl-1,3-butanediol, 3-methyl-1-butanol, 2-methyl-1,3-pentanediol, 3-methyl-1,5-pentanediol, 1,6-hexanediol, 1-octanol, 2-octanol, 3-octanol, 4-octanol, 3-methyl-3-octanol, C9-11 alcohols, benzyl alcohol, phenethyl alcohol, butylhydroxytoluene, m-cresol, hexaflourisopropanol, terpenoids, if n particular thymol and carvacrol, acyclic mronoterpenes, in particular linalool, nerol and lavandulol, monoterpene alcohols, such as menthol, isopulegol, terpinecols (α-, β-, γ- and 5-terpineol), 4-terpinenol (terpinen-4-ol), trans-p-menthano-8-ol, carvacrol, bomeols and geraniol, alkylphenols from lignin, in particular 1-phenylethanol, guaiacol, 4-methylguaiacol, 4-ethylguaiacol, 4-methoxy-α-methylbenzyl alcohol and methyl salicylate, mono-alkoxylated and poly-alkoxylated alcohols, in particular 3-methoxy-3-methyl-1-butanol, 1-methoxy-2-propanol, 3-iso-propoxy-1-butanol and 2-methoxy-1-propanol)
unsubstituted, monosubstituted and polysubstituted carboxylic acids (for example formic acid, acetic acid, trifluoroacetic acid and levulinic acid, diphenyl isophthalate, diphenyl terephthalate) oxalic acid, succinic acid, malic acid, tartaric acid, citric acid, fatty acids (in particular caproic acid, oenanthic acid, caprylic acid, pelargonic acid, capric acid, lauric acid, myristic acid, palmitic acid, margaric acid, stearic acid, arachidic acid, behenic acid, lignoceric acid, cerotic acid, montanic acid, melissic acid, lacceric acid, geddic acid, undecylenic acid, myristoleic acid, palmitoleic acid, margoleic acid, petroselinic acid, oleic acid, elaidic acid, vaccenic acid, gadoleic acid, gondoic acid, cetoleic acid, erucic acid, nervonic acid) and their esters, preferably of the trihydric alcohol glycerol (e.g. tristearin))
unsubstituted, rmonosubstituted and polysubstituted acyclic or cyclic carboxylic acid esters (e.g. acrylic acid esters, especially 1,6-hexanediol diacrylate, benzyl formate, methyl benzoate, ethyl benzoate, benzyl acetate, cinnamon acetate, 2-methylbutyl isovalerate, lactones, in particular δ-decalactone, γ-decalactone, γ-octalactone, γ-valerolactone, δ-dodecalactone, δ-nonalactone, δ-tetradecalactone, γ-dodecalactone, γ-hexalactone, γ-nonanolactone and γ-butyrolactone, alkoxylated carboxylic acid esters, in particular ethyl-3-ethoxypropionate, 3-methoxy-3-methyl-1-butanol acetate, dibasic, esters, in particular adipic acid dimethyl ester, adipic acid diethyl ester, glutaric acid dimethyl ester, 2-methylglutaric acid dimethyl ester, succinic acid dimethyl ester and succinic acid diethyl ester, lactic acid esters, in particular ethyl lactate and methyl lactate, pentyl acetate (amyl acetate), butyl acetate, hexyl butyrate, benzyl acetate, isopentyl acetate, n-butyl glycolate, terpenoid ester, in particular linalyl acetate, geranyl acetate, lavandulol acetate and geraniol butyrate, monoalkoxylated and polyalkoxylated carboxylic acid esters, in particular 3-methyl-1,3-butanediol acetate, 3-methoxy-3-methylbutyl acetate, 3-methoxy-1-butyl acetate, 1-methoxy-2-propyl acetate and 2-(butyryloxy)propionic acid butyl ester, solvents represented by the following formulas (d), (e) and (f):

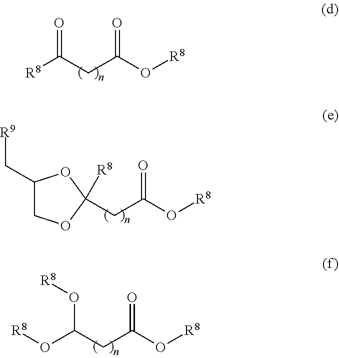

Wherein R⁸ may independently, identically or differently, be a linear, branched or cyclic alkyl group or aryl group; wherein R⁹ may be a hydrogen atom, a hydroxyl group, a linear, branched or cyclic alkyl group or aryl group; wherein n is an integer from 0 to 10, in particular laevulinic acid ethyl ester, laevulinic acid butyl ester, pyruvic acid ethyl ester, phenylglyoxylic acid ethyl ester, ethyl 3-oxobutanoate, ethyl-3-(2,4-dimethyl-1,3-dioxolan-2-yl)propanoate, ethyl-3-[4-(hydroxymethyl)-2-methyl-1,3-dioxolan-2-yl]propanoate, methyl-3,3-dimethoxypropionate, ethyl diethoxyacetate or ethyl 3,3-diethoxypropionate)
oils such as vegetable oils (e.g. rapeseed oil, sunflower oil, olive oil, linseed oil, palm oil and coconut oil), essential oils (e.g. rose oil or lemon oil), mineral oils and silicone oils
unsubstituted, monosubstituted and polysubstituted aldehydes or ketones (for example, n-butanal, isobutanal, acetone, butanone, cyclopentanone, methyl isobutyl ketone, methyl isohexenyl ketones, benzaldehyde, acetophenone, monoterpene ketones and monoterpene aldehydes, such as D-camphor, L-camphor, carvone, nopionone, norcamphor, and citronellal, phenylpropanoids, in particular cinnamaldehyde, monohydroxylated and polyhydroxylated ketones, in particular diacetone alcohol)
unsubstituted, monosubstituted and polysubstituted acetals or ketals (e.g. acetaldehyde diethyl acetal, formaldehyde dibutyl acetal, 2,2-dimethoxyethylamine, acrolein diethyl acetal, phenylacetaldehyde dimethyl acetal, anisaldehyde dimethyl acetal, citral diethyl acetal, isopropylidene glycerol)
unsubstituted, monosubstituted and polysubstituted cyclic or acyclic ether (for example, pyran, 4-methyltetrahydropyran, tetrahydro-2-isobutyl-4-methylpyran-4-ol, oxepan, cyclopentylmethylether, anisole, 2,5-dimethylisosorbide, diphenylether, furan-based ethers like furans, 2-amylfuran tetrahydrofurans, especially 2-methyltetrahydrofuran, tetrahydro-2-methyl-3-furanone, terpenoids, in particular 1,8-cineole, 1,4-cineole, cis-(+)-limonene-1,2-oxide, trans-(+)-limonene-1,2-oxide, limonene-1,2:8,9-dioxides (mixture), α-pinene oxide, and β-pinene oxide and phenylpropanoids, in particular anethole, apiol, dillapiol and estragole
solvents represented by the following formula (g):

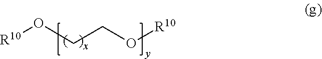

Wherein R¹⁰ may independently, identically or differently, be a hydrogen atom, a linear, branched or cyclic alkyl group, acetyl group, benzoyl group or aryl group; wherein x is an integer from 0 to 17; wherein y is an integer between 1 and 6, in particular propylene glycol n-butyl ether, triethylene glycol monoethyl ether, triethylene glycol monomethyl ether, ethylene glycol dimethyl ether, glycol ether, tripropylene glycol monomethyl ether, dipropylene glycol methyl ether, dipropylene glycol methyl ether acetate, dipropylene glycol dimethyl ether, butyl glycol acetate, butyl diglycol acetate, propylene glycol, tripropylene glycol, ethylene glycol monobutyl ether, diethylene glycol monobutyl ether, triethylene glycol monobutyl ether, diethylene glycol monohexyl ether, diethylene glycol n-butyl ether acetate, propylene glycol-1-methyl ether, glycol ether acetate, 2-ethoxyethyl acetate, ethylene glycol phenyl ether, propylene glycol phenyl ether, dipropylene glycol n-propyl ether, tripropylene glycol n-butyl ether, dipropylene glycol and ethylene glycol diacetate
unsubstituted, monosubstituted and polysubstituted open-chain or cyclic hydrocarbons (for example cycloalkanes, in particular cyclohexane, n-alkanes and iso-alkanes, in particular hexane, heptane, petroleum, paraffins, ISO paraffins, acyclic monoterpenes, in particular myrcene (7-methyl-3-methylene-1,6-octadiene), ocimene (3,7-dimethyl-1,3,6-octatriene) and cosmene, cyclic monoterpenes, in particular p-menthane, p-cymene, β-phellandrene, α-phellandrene, D-limonene, L-limonene, dipentene (racemic mixture), α-terpinene, γ-terpinene, terpinene (mixture of substances), pinenes (α-pinene, β-pinene and δ-pinene), pinane, menthene, camphene, isobornylan, isocamphane, bornane, δ-terpinene (terpinoene), sabinene, α-thujene, β-thujene, caran, carene (3-carene, 2-carene), fenchan, α-fenchen, and β-fenchen, diterpenes, in particular neocembren (cembrene A), sesquiterpenes, in particular valencene)
cyclic and acyclic carbonic acid esters (ethylene carbonate, propylene carbonate, carbonic acid dimethyl ester, carbonic acid diethyl ester, carbonic acid diiphenyl ester)
unsubstituted, monosubstituted and polysubstituted cyclic or acyclic carboxylic acid amides (for example, dimethylacetamide, dimethylformamide, lactams, in particular N-methyl-2-pyrrolidone, N-ethyl-2-pyrrolidone, N-butyl-2-pyrrolidone, N-cyclohexyl-2-pyrrolidone)
monoterpenes with heteroatoms such as menth-1-en-8-thiol and eucalyptus oil
phenylpropenes (eugenol, safrole, myristicin, elemicin, estragole)
vanillin, anisole acetate and isoeugenol, dimethyl sulfoxide, dimethyl sulfone, sulfolane, acetonitrile, dichloromethane, adipoyl dichloride, 1,6-diaminohexane, isopropyl tetradecanoate, Cyrene™/2-methyltetrahydrofuran blend, Cyrene™/γ-valerolactone blend, triethanolamine, diisobutyl ester, dimethyl ester, C9-11 Pareth-6, C12-15 Pareth 7, DOWCLENE™* 16 Series Modified Alcohol, SENSENE™ Solvent, Rhodiasolv® IRIS, GLYCAMAL®, GLYCASOL®, 1,6-anhydro-3,4-dideoxy-β-D-glycero-hexanopyranos-2-ulose, triethyl phosphate, methanesulfonic acid, sulfuric acid, sodium stearate
m-terphenyl, p-terphenyl, mixtures of terphenyls, e.g., SANTOWAX R® mixed terphenyls (® trademark of the Monsanto Company), mixtures of partially hydrogenated terphenyls, e.g., THERMINOL 66® partially hydrogenated terphenyls (® trademark of the Monsanto Company), a mixture of terphenyls and quaterphenyls, e.g., THERMINOL 75® mixed terphenyls and quaterphenyls (® trademark of the Monsanto Company), quaterphenyls and mixture thereof
unsubstituted, monosubstituted and polysubstituted open-chain or cyclic ureas (for example, 1,3-dimethyl-2-imidazolidinone, 1,3.diethyl-2-imidazolidinone, 1,3-dimethylurea)
Isothiazolinone and its subgroups (e.g. methylisothiazolinone, chloromethylisothiazolinone, benzisothiazolinone, octylisothiazolinone, dichloroctylisothiazolinone, butylbenzisothiazolinone)

A water-alcohol-mixture is an aqueous mixture that contains at least one monohydric or polyhydric, e.g. aliphatic, alcohol.

A water-alcohol-mixture may comprise a combination of two or more monohydric and/or polyhydric, e.g. aliphatic, alcohols.

A weight ratio of water and alcohol refers to the ratio between water and the total amount of alcohols, in particular monohydric aliphatic alcohols, in the treating liquid.

The ratio of water and alcohol is given as a percentage and refers to percent by weight.

A water-alcohol-mixture may comprise as main ingredients water and at least one type of, e.g., monohydric aliphatic, alcohol in particular in the proportions indicated herein, and may optionally contain additives such as one or more further solvents which may be for example aromatic alcohols, usually in lower quantities.

A polyhydric alcohol is an organic compound which carries at least two OH groups and may optionally have further substituents or functional groups as defined above.

Examples are, amongst others, glycol, glycerol, triethyleneglycol, propyleneglycol, ethyldiglycol, ethyltriglycol, polyethyleneglycol, butylglycol, butyldiglycol, butyltriglycol, methoxypropylalcohol.

When the term “alcohol” is generally used in this application, this term encompasses at least one alcohol as defined above and a mixture of alcohols.

The term “additional solvent” as used in the present application encompasses a single organic solvent or a mixture of two or more solvents which are used in addition to the alcohol or water-alcohol-mixture building the treating liquid or being present therein as disclosed herein, and do not comprise water or monohydric aliphatic alcohol although it may comprise aromatic alcohols.

Any amount of additional solvent, such as, for example, polyhydric or aromatic alcohol, is added additionally to the amount of treating liquid.

Any additional solvent and/or plasticizer may be present in the treating liquid in an amount up to 49%, preferably up to 20% by weight, for example up to 10% by weight, based on the weight of the amount of treating liquid.

The term “plasticizer” as used in the present application refers to a compound that increases the plasticity of a material, in particular that increases the flexibility of polymers, for example, by decreasing the attraction between polymer chains.

Examples of plasticizers are aromatic esters such as phthalates, benzoates, aliphatic esters such as citrates, adipates, sebacates, cycloaliphatic esters such as cyclohexane dicarboxylic acid alkyl esters.

The term “plasticizer” also encompasses bio-based compounds such as compounds derived from oil, for example soybean oil derivatives, or essential oils such as campher.

The term “functionalizing agent” as used in the present application refers to an agent that adds or introduces a function to the element or to the surface of the element, respectively. Functionalizing agents may for example at certain parameters be present in a treating liquid as a suspension, as a dispersion and/or in solution.

The function may be a chemical, physical, aesthetic, protective, etc. function.

“Solidifying” a powder may be accomplished by melting, sintering, melting, or binding a powder.

The term “chamber” as used in the present application refers to a treatment chamber (herein also: process chamber or main chamber) in which the elements are treated.

The chamber may be any type of container suitable for the application of a treating liquid and/or a functionalizing agent. Preferably, a chamber comprises heating devices and optionally further arrangements for a treatment or optimized treatment of elements, such as for example at least one swirling device, a propeller, a stirrer, a fan, a nozzle, a jet nozzle, a mechanical manipulator, a mechanical vibration device, an external or internal microwave unit and/or a sound unit or ultrasound unit.

The chamber may be a pressure chamber, in some embodiments it is not. In such embodiments it does not have or require, e.g., a cover.

The surface roughness of a material or element refers to the texture on the surface. It is quantified by, e.g., deviations in the profile, i.e. deviations in a direction perpendicular to the surface.

Measured values for the profile are obtained by scanning the actual profile with a probe. Surface imperfections such as cracks, scratches and dents should not be part of the profile and should not be included in the measured value. Roughness parameters that are usually used are Rₐ as the arithmetic mean roughness value, wherein the arithmetic mean value of the absolute values of the profile deviations from the mean line of the roughness profile is measured, or R_{z} as the mean roughness depth, wherein the mean value of i (normally i=5) profile deviations from i sampling lengths are measured.

When surface roughness is referred to in the present application, this refers to Rₐ values, i.e. arithmetic mean roughness values, unless the context indicates or tells otherwise.

The method of the present invention comprises treating elements by applying a treating liquid.

It has been advantageously found by the present invention that the surface of elements may be smoothed by applying a treating liquid comprising water and at least one alcohol as defined in advance (i.e. monohydric or polyhydric) at a predetermined temperature and for a predetermined time, or by exposing the element to such a treating liquid at a predetermined temperature and for a predetermined time.

The method according to the present invention is suitable for treating bulk material, which is understood such that several elements are treated together within the said period, in particular together in a common treating liquid, and are not separated in steps or separated by separating devices.

The method according to the present invention optionally encompasses at least three steps—a) a heating step, b) a smoothing step, and c) a cooling step, as described herein, and may encompass further steps such as a pre-treatment step, a post-treatment step, a functionalizing step, a step of applying vapor, or additional steps.

In several embodiments, the method does not encompass a heating step, and in particular no heating step as described herein. In such embodiments, the smoothing step is based on the presence of a treating liquid or a mixture of or with treating liquid and elements of desired smoothing temperature as disclosed herein, in particular for the smoothing step b).

Thus, the method for treating polymer elements obtained by an additive manufacturing process encompasses, e.g., the following steps:
a) optionally, a heating step for heating a treating liquid to a temperature below an upper threshold temperature, wherein the upper threshold temperature preferably is in a range of approximately 1° C. to 150° C. below the melting temperature of the polymer from which the polymer elements are or have been formed,
b) a treatment step, in particular a smoothing step, in which the polymer elements are in contact with the treating liquid in the chamber at a temperature above a lower threshold temperature and below the upper threshold temperature for a predetermined period, optionally under conditions in which the treating liquid is in liquid state,
c) optionally a cooling step for cooling the polymer elements, preferably to a temperature of at least 5° C. below the upper threshold temperature, particularly preferably to a temperature below the lower threshold temperature, wherein the treating liquid comprises water and at least one alcohol, e.g. a monohydric or polyhydric, preferably aliphatic, alcohol, wherein the weight ratio of water to alcohol is in a range from 98:2 to 2:98.

The above steps a) to c) of the method optionally take place in this order.

According to a preferred embodiment of the present invention, the upper threshold temperature may be in a range of 50° C. to 325° C. such as 80° C. to 190° C. or may be determined as such.

In some embodiments according to the present invention, it has been advantageously found that using a mixture of a monohydric aliphatic alcohol with water allows adapting a suitable period for the smoothing reaction.

It was also found that there is a lower threshold temperature below which no or hardly any smoothing occurs.

If the temperature is reduced after treatment step b) or smoothing step b), for example by cooling down, the treatment procedure, e.g. the smoothing procedure, will become slower and/or stops.

Below the lower threshold temperature, no treatment effect or smoothing effect, or no significant treatment effect or smoothing effect, occurs.

The lower threshold temperature depends on the treating liquid, on the cooling rate at which smoothing stops as well as on the size and shape of the elements and on the polymer of which the elements are made.

The optimal smoothing time, i.e. for example the duration of the smoothing step b), and the optimal cooling rate may be determined by routine experiments.

In some embodiments of the method according to the present invention, the treating liquid preferably comprises water and at least one, preferably monohydric, preferably aliphatic, alcohol, such as for example ethanol, for example in a weight ratio of water to alcohol of 98:2 to 2:98, such as, e.g., 85:15 to 20:80.

In other embodiments, the treating liquid preferably comprises water and polyhydric alcohol, such as for example propyleneglycol, for example in a weight ratio of 99:1 to 1:99, such as 70:30 to 2:98.

In other embodiments, alcohols are present entirely or at least largely in pure form or consist of mixtures of different alcohols, such as for example pure propyleneglycol or a mixture of propyleneglycol and triethyleneglycol and/or polyethyleneglycol. Likewise, glycols may be mixed with simple alcohols such as for example ethanol or isopropanol as treating agents, with or without adding water.

In some embodiments, granular media are present in the treating liquid. These may preferably serve as separating agents for elements and/or may advantageously change the surface properties of the elements in that the geometry of the granular media is structurally at least partially visible on the surface through preferably plastic deformation, a mechanical material shift on the surface of the elements is caused or promoted and/or granular media generate material removal from the elements.

The use of granular media may reduce the sticking of the polymer elements, especially when treating bulk material. In other words, the intensity of the smoothing may be increased, i.e. a more smoothed result may be achieved without the polymer elements sticking together and/or causing pressure marks between each other and/or against the container wall.

A granular medium consists of, or comprises, many solid particles such as grains or spheres. The physics or effect of granular media is primarily based on mechanical interactions.

In some embodiments, the granular media are made of, or comprise, ceramic, glass, metal, plastic such as for example PVDF, PTFE, PFA, FKM, FFKM, PEEK, PEEK, silicone or thermosets, elastomers such as TPE, minerals such as corundum, natural materials such as nutshells or mixtures/compounds thereof.

In several embodiments, the granular media are in spherical shape.

In other embodiments, the granular media may be in any other form. For example, they may be cylinders, pyramids or cuboids.

In certain embodiments, the granular media may have sections in spherical, cylindrical, pyramidal, cuboidal shape or differently shaped sections.

In some embodiments, the size, such as e.g. length, width, diameter, of the granular media ranges from approximately 0.1 mm to about 30 mm, preferably their size is between 0.4 mm and 12 mm, such as for example between 0.5 mm and 5 mm.

Larger diameters or edge lengths than approximately 0.1 mm are particularly advantageous because they do not tend to stick within the softened polymer surface and, therefore, do not remain permanently in or on the polymer element.

Granular media no larger than approximately 30 mm have proven to be particularly advantageous in terms of preventing or greatly reducing sticking.

In several embodiments, the granular media have different sizes and/or different shapes and/or are made of different materials.

In some embodiments of the method according to the present invention, at least temporary mixing of the treating liquid with the polymer elements and the granular media is provided.

In some embodiments, the mixing takes place in the form of flow and/or sound or ultrasound, respectively, and/or vibration and/or pulsation and/or by electromagnetic fields and/or by stirring and/or by swirling and/or possibly other forms such as pressure changes.

In some embodiments, granular media may be made of at least one plastic abrasive A comprising at least one particle PA1 of at least one polymer KA1 and at least one foreign particle FA1, wherein the foreign particle FA1 is not an abrasive grain.

In several embodiments, granular media may be made of at least one plastic abrasive A comprising at least one particle PA1 of at least one polymer KA1 and at least one foreign particle FA2, wherein the foreign particle FA2 is an abrasive grain.

In some embodiments, at least one of the granular media just mentioned is not to be designed and/or used as an abrasive, but is preferably designed with larger dimensions and/or formed in geometries which are not at least approximately spherical, wherein such embodiments of granular media are preferably proposed for a treatment according to the present invention of elements which can be at least partially compared with a slide grinding process in its cause and/or effect, wherein the difference may consist, for example, primarily or among other things, in the fact that granular media, in addition to having a surface-influencing and/or modifying effect, may also simultaneously act as a separating agent between the elements and/or that granular media preferably leave (permanently) clearly recognizable impressions in the surfaces of elements after the treatment in the form of at least components of the geometry of the granular media, which may emerge as a kind of texture or microstructuring.

A (plastic) abrasive in the context of the present invention may comprise an agent comprising at least one type of particle, for example the particle PA1, in the treatment according to the present invention using granular media, which may optionally be accelerated on the element to be treated with the aid of a medium, in particular of a fluid and/or of a treating agent. In particular, a plastic abrasive may be at least partially consist of a plastic.

A particle in the context of the present invention may comprise a single particle or a lot of particles, which are in particular of the same type.

An abrasive grain in the context of the present invention may be understood as a particle which has an abrasive ability and has the task of polishing and cutting the workpiece within at least one chamber. In most cases, the abrasive grain is finely dispersed in a base material encompassing a raw material polymer and compounding agent.

In several embodiments, in the use of the plastic abrasive A according to the present invention, the polymer KA1 is selected from the group consisting of polyamides, resins, polyesters, polystyrenes, polyolefins, polyvinyls, rubbers, polyvinyl chlorides, polyphenylenes, polyethers, polyurethanes, polysaccharides, polyimides, polyacrylates, silicones, and blends and copolymers thereof.

In some embodiments, the foreign particles FA1 in the use according to the present invention are selected from the group consisting of minerals, soot particles, carbon fibers, paint particles, ceramics, polymers, alloys or glasses, most preferably glasses. Glasses may be, for example, quartz glasses, soda-lime glasses, silicate glasses, alkali-silicate glasses, alumino-silicate glasses, borosilicate glasses and glass ceramics. In general, glasses are compounds which have a SiO2 content of at least 20%.

In several embodiments, the foreign particle FA1 is of non-metallic origin.

In some embodiments, the foreign particle FA1 is of metallic origin, for example when granular media within the chamber are to be set in motion and/or heated using supplementary forms of energy such as, for example, electromagnetic induction. In this, in the use according to the present invention of the plastic abrasive A, the foreign particle FA1 is preferably not an abrasive grain.

In several embodiments, the use of foreign particles FA1 with high densities is advantageous. Preferably, in the use according to the present invention, the density of the foreign particle FA1 is in a range from 0.7 to 8 g/cm3, in particular preferably, in the use according to the invention, the density of the foreign particle FA1 is in a range from 2.5 to 8 g/cm3.

In some embodiments, the granular media serve in addition to reducing possible sticking of polymer elements also to microstructuring the polymer elements. In other words, the geometries of the granular media, or parts thereof, appear on the surface of the polymer elements. As the polymer elements soften during the treatment process, these effects can become increasingly pronounced. When the treatment temperature is subsequently reduced and the surfaces are therewith preferably solidified or cured, these microstructures may become permanently visible.

In certain embodiments, the structuring of the surface of the polymer elements may optionally be a separate, additional treatment step. Depending on which surface texture is supposed to be achieved, this may be specifically brought about by the appropriate choice of granular media in connection with parameters such as time and temperature as well as the intensity of the circulation. Alternatively, for example, if no surface structures are to be created primarily, the treating liquid, with or without granular media, may preferably be used as a pure separating agent by correspondingly differently selecting the parameters and/or optionally the properties of the granular media.

In several embodiments, a complementary effect can be achieved on the color of “non-white” polymer elements, such as by manufacturing using MJF or HSS. For example, MJF elements have a black color on the inside and are preferably gray or white on the surface due to the bulk material process without granular media. The polarity of the granular media may lead to greater mixing on the surface, so that the elements become more black or dark gray. This is preferably the case with granular media with non-polar properties. Granular media with strong polar properties may intensify the effect of gray or white coloration.

In some embodiments, the granular media may be used simultaneously or in a preferably upstream process step for depowdering the polymer elements, generally before the actual smoothing. In that, the powder residues should preferably be filtered out. At the same time, it is advantageous that the granular media preferably have a particle size of approximately greater than 0.2 mm, particularly preferably greater than 0.4 mm, so that they are not filtered out with the residual powder, but are preferably not aspirated by the pump in the first place. The residual powder usually has a particle size of approximately 0.05 mm.

In several embodiments of the method according to the present invention, before the smoothing step b), the elements are held for a predetermined minimum duration in an upper section of the chamber in which the smoothing step b) takes place or will take place and which is filled with gas for at least one heating step and/or misting step and/or a step of applying vapor.

The minimum duration may range from approximately 30 seconds to approximately 12 hours. This depends heavily on what is to be achieved, e.g. elements may preferably only be preheated or saturated e.g. with water (vapor). Alternatively or additionally, physical changes to the surface, for example an inward shift of the carbon black, may already be achieved in this step.

If for example water/ethanol is used as the treating liquid, the elements may be saturated with protective water (vapor) and may be brought to the higher temperature in a shorter time than without the use of vapor. During the actual smoothing process, such water storage may ensure that the softening of the surface is less profound and thus deformation of e.g. thin contours is less likely to occur and/or elements are less prone to sticking.

In these embodiments, the system is preferably designed such that the treating liquid does not completely fill the chamber, herein also: process chamber, so that there is a gas area in the upper part of the chamber in which the polymer elements remain before the actual treatment process. During tempering the chamber, a preferred vapor phase is created in which the polymer elements can be pretreated and/or pretempered before they are introduced into the treating liquid. This may be achieved by the possible evaporation of the solvents, here depending on the pressure.

In some embodiments, the gas pressure, preferably nitrogen pressure, in an upper section of the chamber is controlled or set during the step of applying vapor. Preferred values range from 1 bar (atmospheric pressure) to approximately 20 bar, or from 1,000 hPa to 20,000 hPa.

By precisely controlling pressure of the gas, which is introduced into the process chamber as process gas, the composition of the gas phase may preferably be controlled.

In several embodiments, the step of applying vapor corresponds to, or overlaps with, the heating step a).

In some embodiments, the treatment results may be optimized by the pre-treatment or the pre-tempering, respectively, and/or the treatment time of the polymer elements in the treating liquid may be reduced.

Due to low or no additional gas pressure at the beginning of the heating phase of the treating liquid, ethanol may evaporate from approximately 78° C. and water from approximately 100° C., or azeotropic phases in a temperature range lying in between. The resulting amount and concentration of vapor and/or the vapor ratio is settable and controllable, at least to a certain extent, by controlling the gas pressure in the process chamber. Mixing of any prevailing vapor phases, i.e. areas in which there are different vapor concentrations and/or temperature windows, may be achieved by suitable apparatuses, such as for example propellers, which are preferably positioned at the top of the chamber, and/or other drive devices such as sound waves and/or other apparatuses for assisted gas circulation.

The polymer elements are present in this design at least preferably or partially in the gas or vapor zone during the heating process of the treating agent and are specifically pretreated and pretempered there.

In some embodiments, the water of the treating liquid is or will be replaced or exchanged in whole or in part by glycerol, by at least one oil or fat or by a glycol, in particular a propyleneglycol, a polyethyleneglycol or a trieethyleneglycol.

In some embodiments, the interaction between the treating agent and the elements is not stopped immediately after separation of the elements from the treating agent, but is continued by the (residual) amounts of treating agent remaining on and/or in the surface in air, in vacuum or in the presence of inert gas for a certain time, for example, up to about 120 minutes, preferably up to 60 minutes, particularly preferably up to 30 minutes, such as for example up to 10 minutes. Such treatment, like the one described below, may be additionally influenced and/or intensified by heat, such as for example a linear and/or turbulent flow of air or hot air and/or by extended forms of energy such as for example pulsation, microwaves, sound or ultrasound.

In some embodiments, an advantageous change in the surface properties and/or surface roughness of elements does not already begin at and/or during contact with the treating agent, at least not a perceptible and/or measurable change, but only after separation of the elements from the treating agent, such as for example after removal, preferably only upon contact with a gas or inert gas which, if required, may exert at least a local overpressure on the elements and preferably can be heated or cooled, preferably, for example, between approximately 5° C. and approximately 160° C., such as approximately 10° C. to approximately 80° C. In the methods just described, the elements may, after separation of the contact between at least one treating agent and the elements, such as for example by removal from a liquid treating agent bath or by stopping spraying and/or misting as described, still further carry out the process according to the present invention of an advantageous change in surface properties (in the case of thinner components also of complete or partial element properties) for a certain time, for example up to 120 minutes, wherein these methods may be combined in this state with further methods such as functionalization, coloring, flocking, microstructuring, printing, dimensional and/or shape changes by compression, stretching, bending or straightening, and wherein the treating agents used may preferably consist of at least an ester, an ether, an acetal, a glycol, such as a propyleneglycol, a triethyleneglycol, a polyethyleneglycol and/or of at least a fatty acid, such as for example a palmitic acid and/or of at least one oil.

In several embodiments, depowdering of polymer elements is preferably carried out in combination with granular media, for example by circulation, by pressure fluctuations, by pulsation, by magnetic fields, by ultrasound and/or by sound waves.

In some embodiments, the depowdering may be carried out by combining granular media with liquid treating agents, preferably consisting of alcohols and/or water.

In some embodiments, the depowdering may be performed as a pre-treatment step and/or may be combined with the smoothing step.

In this, for example an ethanol-water-mixture may put the residual powder sticking to the polymer elements into a kind of greasy state (soap-like) from approximately 80° C. (depending on the concentration). In this state, most of the residual powder does not detach statically, but it may be removed better and more gently by additional mechanical/physical processing such as vibratory grinding and/or blasting, preferably in connection with granular media and/or by blasting using a liquid treating agent. Depowdering may be carried out in combination with granular media, e.g. by ultrasound or vibration, as well as without additional media in the treating agent, e.g. with pure ethanol/water or isopropanol/water or glycols/water (plus any liquid additives, if necessary).

Pressure differences in the chamber caused by actively increasing or decreasing the gas pressure within the chamber may provide an additional effect of depowdering. This may generally be caused by the change from compression to expansion. The second explanation for stronger depowdering in relation to the chamber pressure or gas pressure may be the fact that at a gas pressure close to or below the treating agent vapor pressure in relation to the prevailing temperature of the treating agent, vapor bubbles form within the treating agent (i.e. it begins to boil) and these provide additional kinetic energy on the surface of the polymer elements, which can better detach residual powder.

This gas pressure, preferably nitrogen pressure, may be used in the bulk material process to pre-treat polymer elements located in the gas area or in the vapor phase with water or alcohol-water and/or to bring them to a certain temperature level as uniformly as possible.

Alternatively or additionally, in some embodiments, the polymer element properties, the strength and/or structure of the smoothing and the possible sticking of polymer elements may be advantageously influenced by the targeted introduction of treating agents and/or by the presence of special guiding arrangements for the flowing treating agent such as for example, baffles on the chamber wall and/or by swirling with swirling devices and/or by stirring by stirrer or propellers during the circulation. If a flow that circulates the contents of the chamber in an annular flow is selected for the introduction of the treating agent, this results in good heat distribution from the chamber wall when it is heated. If at least part of the flow from below is also selected for an upflow direction, a buoyancy is generated in relation to the polymer elements, thus counteracting gravity and at the same time achieving a higher mixing/circulation of the polymer elements (ring flow and upflow through pump circulation).

Here, the term “upflow” describes a preferably deliberately induced flow or an at least partially exerted movement of the treating agent and/or of the granular media and/or of the elements in a direction that extends within a chamber at least in sections and at least approximately from bottom to top. An “upflow” may be achieved for example by the directed flow of a pump, in that the outlet of the pump within a chamber is directed at least largely from bottom to top.

The term “annular flow” describes a preferably specifically induced flow or an at least partially exerted movement of the treating agent and/or the granular media and/or the elements in a direction which extends within a chamber at least in sections and at least approximately in a circular, spiral or helical shape, i.e. at least partially exerts a rotational movement which can be influenced, among other things, by the shape of the container wall of the chamber. An “annular flow” may be achieved, for example, by the directed flow of a pump in combination with a container wall, in that the outlet of the pump extends at least partially and approximately in a tangential direction to a housing wall or container wall.

In several embodiments, a device for measuring the surface smoothness of the elements present in the chamber, or at least of one thereof, is provided. This device may be or comprise, for example, an optical measuring device. It may be a mechanically acting device, or combinations thereof. For example, a sharp object may be provided which presses into one of the elements as a test, while its surface becomes increasingly softer as the smoothing progresses. The penetration depth of the tip of this object into the softened surface may be determined optically or by other means and allow conclusions to be drawn about the strength of the smoothing that has already taken place. Target parameters, a rating scale, reference values, reference images, etc. may be provided and stored in advance for a conclusion, e.g. in the control device or a data or image memory connected to it.

In some embodiments, a camera and/or an optical microscope and/or an infrared measuring device may be provided for checking or monitoring the smoothing.

In several embodiments, the apparatus is provided with several reservoirs for or with treating liquid, or receptacles therefor.

In some embodiments, existing reservoirs for or with treating liquid may be marked in different ways, for example with QR codes for automatic recognition.

In these embodiments, it may additionally be provided that reservoirs preferably marked in this way are preferably replaced independently by the apparatus, e.g. after a certain number of smoothing cycles, over which the treating agent may have changed, e.g. in its concentration and/or consistency. Several reservoirs may therefore be provided; they may be kept separably or not firmly connected. The preferably automated change between the contents of different reservoirs with different treating liquids, or which have at least individual components of the treating liquid, may take place, for example, via valves, which may represent different fluid communications within the apparatus, such as multi-way valves.

In several embodiments, at least one sensor is provided for determining the concentration of the treating liquid. It may further be provided to adjust the concentration of the treating liquid, in particular in response to the sensor feedback, and/or the smoothing parameters during and/or between the smoothing steps of successive smoothing cycles or smoothing batches.

In some embodiments, at least one filter is provided in or on the apparatus, in particular for filtering suspended solids and or detached powder or polymer particles in or out of the chamber. Such filters may be, for example, coarse screens and/or fine screens or other filter media such as filter paper, filter sponge or filter wadding. Any other filter medium known to the skilled person may be used. The filter medium may be used both during operation, for example by introducing it in the flow circuit of a circulation pump that circulates the treating liquid before, during and after smoothing. A suitable filter unit may also be implemented in a separate flow circuit which is primarily intended only for filtering the treating agent. A filter may be arranged such that to clean the treating agent which may be contaminated with particles.

In several embodiments, the collection of measurement data is provided. The measurement data may, for example, be or encompass values for temperature, pressure, treating agent concentrations or the like. Measuring the polymer element characteristics such as surface finish, surface roughness, surface hardness, bending stiffness, tensile strength, compressive strength, or other polymer element measurement data known to the skilled person may also be provided inside the chamber before, during, and after the treatment steps.

In this, in certain embodiments, an evaluation of the parameter or parameters may result in an adjustment of temperatures, pressure, periods, concentrations, heating rates, cooling rates, temperature-time response during the process.

In some embodiments, a reference polymer element may be provided for measuring, e.g. a test rod, a tensile rod, a cuboid, or also other test parts in which such shapes are used. In particular, also internal contours such as bores and/or channels, preferably of reference polymer elements, may be provided with such measuring instruments. In this, the reference polymer elements have the advantage that no usable polymer elements are damaged by the measurements and at the same time, these reference polymer elements preferably represent standardized shapes and geometries, whereby such measurements may always be directly compared with each other over time and such data may also be compared and adapted with other systems and/or at other locations. Preferably, such reference polymer elements are manufactured in SLS, MJF or HSS processes together with the polymer elements to be smoothed, in order to be able to document parameters exerted on the polymer elements to be smoothed during printing, such as the condition of the raw material/powder, e.g. aging, the exact temperature data in the build-up process and other data or their effect, and/or to be able to incorporate them as far as possible in the measurement and/or adjustment of the smoothing. Such reference polymer elements may be provided with surface coding so that they can be archived for backup with unique assignment.

In several embodiments, the device is connected in signal communication with further devices of this type and/or with an evaluation device, or a signal communication may be prepared for this purpose. Such communication or networking may serve for analyzing and/or adjusting treatment parameters of one or more of the interconnected devices.

In some embodiments, an emergency power system or rechargeable battery system is provided in or on the apparatus. With said system, at least the necessary maintenance of control for condition monitoring and/or activation of an emergency program after a power failure may be performed; it should still be possible to switch valves for inert gas and/or other valves even after a power failure, cooling liquid is still circulated by a pump at least to the necessary extent, and/or a valve is opened so that, for example, tap water can be conveyed through the system's cooling device by its own pressure.

In certain embodiments, the at least one additional solvent is selected from substituted or unsubstituted C₆-C₁₂ aromatic alcohols, polyhydric alcohols selected from glycerol and glycols, esters, ethers, ketones, lactones and DMSO or mixtures thereof, wherein the solvent is DMSO or γ-butyrolactone, and/or wherein the plasticizer is selected from aromatic esters, aliphatic esters, cycloaliphatic esters, biobased compounds, wherein the plasticizer is preferably at least one of phthalates, benzoates, citrates, adipates, sebacates, cyclohexanedicarboxylic acid alkyl esters, fatty oils, essential oils.

In several embodiments, a plurality of polymer elements may be treated in the same method.

In particular, the method of the present invention may be applied to any element achieved by an additive manufacturing process from a polymer material which is softened and/or dissolved by the treating liquid of the present invention at the application temperature of the treating liquid as desired for smoothing (herein also: smoothing temperature).

Polymers used in additive manufacturing processes are known to the skilled person.

Examples of polymers that can be used as a building material to form an element are thermoset or thermoplastic polymers. Materials that are particularly useful in powder-based additive manufacturing processes are thermoplastic polymers such as polyamides and thermoplastic elastomers. Examples of suitable polymers and polymer classes are polyamide, acrylates such as polymethyl methacrylate (PMMA), polyoxymethylene (POM), polyethylene terephthalate (PET), polyethylene terephthalate glycol (PETG), polyether block amide (PEBA), polycarbonates (PC), polyethylene furanoate (PEF), polyurethanes such as thermoplastic polyurethane (TPU), polysulfones (PSU) such as polyether sulfones (PESU) and polyphenylsulfones (PPSU), polyether ether ketones (PEEK), polyetherketone (PEK), polyetherketoneketone (PEKK), polyimides, polyetherimides (PEI), styrene polymers and copolymers such as acrylonitrile butadiene styrene (ABS), acrylonitrile styrene acrylate (ASA) or triblock polymers of polystyrene and poly(ethylene oxide) blocks (ABA) or a thermoplastic polymer comprising polyetherimide and polycarbonate, which is available as Ultem 9085, or copolymers, blends or mixtures of all the above-mentioned materials.

Furthermore, the method according to the present invention may also be used to treat elements based on photopolymers for example acrylates, i.e. elements achieved by methods such as stereolithography (SLA), DLP or other light-based methods such as polyjet or multi-jet. It has been found that the method of the present invention may advantageously be used for these types of polymers as well, if the treatment step is performed before or between sub-steps of an optional post-curing.

The method of the present invention is particularly useful for elements obtained from polyamide-based polymers and copolymers.

Polyamide is used in various forms. Suitable polyamides are aliphatic, partially aromatic and aromatic polyamides, for example polyamide 12 (PA12), polyamide 6 (PA6), polyamide 6.6 (PA6.6), polyamide 11 (PA11), PA 4.6 (PA4.6), polyamide 612 (PA612), polyphthalamide (PPA) or thermoplastic co-polyamides or mixed or filled polyamides such as a mixture with metal powder, for example a mixture of aluminum powder and polyamide powder available as alumide, or polyamide powder filled with particles such as glass particles or copolymers, mixtures or blends thereof. It has been realized that PA12 or filled PA12 is particularly suitable for a method as described and claimed.

Elements that can be treated or smoothed by the method of the present invention may be, for example, those produced by an MJF, HSS, SLS process using, for example, polyamide powder or TPU powder as a building material and an energy source such as laser or infrared radiation.

Elements obtained by filament extrusion such as FFF or FDM, by granule extrusion or pellet extrusion may also be treated with the method of the present invention. Elements from other additive manufacturing processes known to the skilled person may also be provided and treated with the method according to the present invention, for example light-induced processes such as DLP, SLA or polyjet. Also elements obtained by other powder processes, such as for example a binder jet process, may be treated, smoothed and/or functionalized.

According to the present invention, the elements are treated with a treating liquid. This contains at least one, and may comprise two or more, monohydric or polyhydric, e.g. aliphatic, alcohols and/or further solvents and/or additives.

It has been found that a treating liquid comprising a water-alcohol mixture as defined in the claims or disclosed herein is useful to treat the surface of elements obtained by additive manufacturing, in particular to smooth the surface and possibly to improve properties such as color, gloss, texture, adhesion, anti-adhesion, electrostatic charge, electrical conductivity and/or to functionalize the surface or parts thereof. One or more alcohols may be used in liquid state, depending on the polymer to be treated.

Suitable alcohols are primarily aliphatic C₁-C₁₀ alcohols.

Examples of aliphatic C₁-C₁₀ alcohols that are well-suited as treating liquids are amongst others ethanol, isopropanol, propanol, n-, iso- or tert. butanol, methanol or any mixture thereof. Ethanol is a monohydric alcohol which is very suited for the method of the present invention.

According to a preferred embodiment of the present invention, the treating liquid may comprise water and ethanol in a weight ratio of 98:2, or 95:5, to 10:90 or 5:95 or with even less water content and/or the treating liquid may be applied at a temperature in the range of 100° C. to 180° C. under the conditions where the treating liquid is in liquid state.

In some embodiments, the treating liquid is or comprises propyleneglycol. The propyleneglycol may or may not have water added to it. At least one (further) alcohol may or may not be added to the propyleneglycol.

Propyleneglycol smoothens, without the addition of water, in particular the following polymers by dipping: PA12 from approximately 145° C., PA11 from approximately 145° C., TPU (preferably TPU01 from BASF) from approximately 100° C.

80% propyleneglycol with 20% weight units of water and/or polyethyleneglycol and/or triethyleneglycol and/or glycerin and/or oil such as rapeseed oil smoothens the following polymers, in particular by dipping: PA12 from approximately 150° C., TPU (preferably TPU01 from BASF) from approximately 115° C.

In several embodiments, the treating liquid is pure or nearly pure propyleneglycol (up to 95% by weight). Propyleneglycol may therefore be used in pure, or almost pure form without corresponding additives such as water or other inactive, liquid substances for smoothing by dipping or in bulk, respectively.

In some embodiments, a mixture of at least one oil such as rapeseed oil and a glycol such as propyleneglycol, preferably at temperatures between 100° C. and 180° C., may be used.

In some embodiments, a mixture of propyleneglycol and triethyleneglycol may be used as a treating liquid preferably for treating TPU01 from BASF at temperatures of 100° C. to 140° C.

In some embodiments, the treating liquid may be selected from, or comprise, at least one treating agent such as glycerol, isopropanol, ethanol, propyleneglycol, dipropyleneglycol, tripropyleneglycol, polyethylene glycol, triethylene glycol, diethylene glycol, ethylene glycol, ethyl diglycol, ethyl triglycol, polyethylene glycol, butyl glycol, butyl diglycol, butyl triglycol, methoxypropyl alcohol, ethyl acetate, methyl acetate, butyl acetate, amyl acetate, acetone, butanone, iaobutanol, 1-butanol, benzyl alcohol, γ-butyrolactone, propylene carbonate, 1,3-butanediol, 1,4-butanediol, benzyl alcohol, 1,2-isopropylidene glycerol, 3-methoxy-3-methyl-1-butanol, oils such as sunflower oil and water, or the like.

It has been advantageously recognized that the smoothing effect of the treating liquid used by the present invention may in some cases be improved by adding at least one plasticizer and/or at least one additional solvent.

Therefore, for those elements which are difficult to smoothen or for which a high temperature and/or pressure would be required, the addition of at least one plasticizer may improve the smoothing results and may reduce the temperature and/or pressure to be applied.

Preferably those which are non-toxic are used.

Plasticizers which are compatible with the polymer used to produce the elements are particularly suitable. Examples of plasticizers are aromatic esters, aliphatic esters, cycloaliphatic esters and bio-based compounds such as phthalates, benzoates, citrates, adipates, sebacates, cyclohexane dicarboxylic acid alkyl esters, oils, fatty oils and essential oils.

The plasticizer is used in an amount that provides for improvement of the desired effect.

An amount of 0.1 to 20% by weight, such as 1 to 10% by weight, for example 2 to 7.5% by weight, based on the total weight of the treating liquid, may be used. In some embodiments, the amount of plasticizer may also exceed 20% by weight, such as for example up to 50% by weight or more.

Furthermore, the treating liquid may contain at least one additional solvent, preferably up to 20% by weight, in order to improve the smoothing effect.

Without being bound by any theory, it is assumed that the additional solvent has the function of a solubilizer, i.e. supports and promotes the smoothing effect of the alcohol. Therefore, the additional solvent may be a solvent that is compatible with the polymer used to manufacture the element and with the treating agent. Solvents found useful may be selected from substituted or unsubstituted C₆-C₁₂ aromatic alcohols, polyhydric alcohols selected from glycerol and glycols, esters, ethers, acetals, ketones, lactones, and DMSO.

The amount may be as little as 0.5% by weight or less and up to 20% by weight, for example up to 10% by weight.

The method of the present invention preferably comprises at least three steps as described above.

The treatment time of an element depends on various factors, such as material, shape and size of the element to be treated, type of treating liquid, applied temperature and pressure, surface roughness of the element to be treated, and others.

In the heating step a), the treating liquid comprises the polymer elements to be treated, and is in contact with them during heating, or said heating step a) encompasses heating the treating liquid at least to the lower threshold temperature, up to or beyond the upper threshold temperature, and that the polymer elements are separately heated in for example an aqueous or non-aqueous solution to a temperature below the upper threshold temperature, and wherein for or in step b) the treating liquid and the polymer elements are brought into contact for smoothing.

In heating step a), the treating liquid, and optionally the polymer elements, are preferably heated to a temperature below the temperature used for smoothing.

In one embodiment, the treating liquid and polymer elements are heated together so that smoothing does not begin, i.e. to a temperature below the lower threshold temperature.

With this pre-treatment the components are saturated with the treating liquid or eventually with water, or in the case of shorter periods, only their surface is saturated. At the same time, the components are brought to a higher temperature (as homogeneously as possible and, if possible, also in the component core). In this way, there can be less distortion due to smoothing.

Preferably for this embodiment, in step a) the treating liquid with polymer elements is heated to a temperature in the range from 80° C. to 170° C., preferably over a period of 5 seconds to 24 hours.

In another embodiment, the treating liquid is heated separately from the polymer elements and is added to the polymer elements only for the smoothing step or is added at first for this step.

In this embodiment, the treating liquid may be heated to a temperature between a lower threshold temperature and an upper threshold temperature or even above, as the temperature of the liquid decreases upon contact with the elements. Both embodiments have advantages. When heating liquid and elements together, the procedure is simple. When heating liquid and elements separately, the process is more flexible and energy may be saved.

According to a preferred embodiment of the present invention, the heating step a) may be carried out at a temperature in the range of 40° C. to 200° C. for a period of 5 seconds to 24 hours.

According to another preferred embodiment of the present invention, in said smoothing step b), a temperature above the lower threshold temperature and 1° C. to 30° C. below the upper threshold temperature may be maintained for a period of 1, 2 or 3 seconds to 300 minutes.

There are two critical points during smoothing or with regard to smoothing step b): the upper threshold temperature and the lower threshold temperature.

Both temperatures may be determined by a skilled person as described below. When treating the polymer elements, care must be taken to ensure that the elements are not exposed to temperatures exceeding the melting temperature of the polymer from which the elements are built. Therefore, the upper threshold temperature is below the melting temperature, at least 1° C. below, and it may optionally be in a range of 1° C. to 150° C. such as 1° C. to 80° C. below the melting temperature. The upper threshold temperature is specific for the combination of treating liquid and polymer used in the method. It is the temperature beyond which the element is at least partially deformed or destroyed. This is the upper limit for the smoothing step. The lower threshold temperature is the temperature for a specific treating liquid and polymer at which smoothing starts. This temperature may be determined as described below.

Thus, the smoothing step b) is carried out at a temperature which is between the lower threshold temperature and the upper threshold temperature and is preferably close to the upper threshold temperature, for example 1° C. to 30° C., such as 2° C. to 15° C., normally 2° C. to 10° C. below the upper threshold temperature.

The lower the temperature and the closer it is to the lower threshold temperature, the longer the time period required for treatment or smoothing. Smoothing periods of more than 30 minutes are less preferred, as longer treatment periods might lead to destruction of the element and there will be the risk of lower quality. Time periods in the range of 10 seconds to 20 minutes, such as 20 seconds to 10 minutes, have proven to be preferred. The closer the treatment temperature is to the upper threshold temperature, the faster the smoothing reaction and the shorter the smoothing period. The upper threshold temperature is specific for each combination of treating liquid and polymer and also depends on the apparatus and conditions used for the smoothing process.

For determining the upper (static) threshold temperature, polymer elements are brought into contact with a stationary or non-moving treating liquid at a predetermined temperature for 30 seconds and are immediately cooled thereafter.

Typical cooling rates are between 1° C./minute and 60° C./minute. Subsequently, the elements are analyzed. If the elements have been destroyed or the surface shows signs of deterioration, the treatment was beyond the upper threshold temperature and the test is repeated at 5° C. or 1° C. or 2° C. below the previously applied temperature. If the element has an intact surface, the test may be repeated at a slightly higher temperature, e.g. 1° C. or 2° C. higher. Hence, the upper threshold temperature may be identified or determined with just a few experiments.

Determining the upper threshold temperature may be part of the method according to the present invention, as may determining the lower threshold temperature.

Alternatively, the upper threshold temperature may be determined upstream of the method according to the present invention. The result of this determination may be used when carrying out the method according to the present invention.

The lower (static) threshold temperature is the temperature at which treatment or smoothing starts. It is specific for each combination of polymer and treating liquid and may be determined as follows. Elements obtained by additive manufacturing from a specific polymer, such as polyamide, are brought into contact with a treating liquid with a predetermined composition, for example a combination of ethanol and water with an ethanol to water ratio of 60:40. The treating liquid in contact with the elements is heated to a temperature under conditions at which the treating liquid is in liquid state, and this temperature is maintained for a predetermined period, for example 1 to 10 hours, such as for example 2 to 6 hours, wherein the treating liquid and the elements rest during the contact. After this predetermined time period, the elements are cooled and examined to determine whether an advantageous change in the surfaces and/or smoothing has occurred. If the elements show no and/or slight signs of smoothing, the test temperature is below the lower threshold temperature. If there are slight signs of smoothing, the temperature is close to or at the lower threshold temperature.

As already mentioned above, the lower threshold temperature is the temperature at which smoothing starts. In other words, elements may be stored in the treating liquid for a long time, provided that the temperature is below the lower threshold temperature. It may be advantageous to store the elements to be treated for some time, for example 5 minutes to 24 hours, for example 15 minutes to 10 hours, in particular 30 minutes to 5 hours, in the treating liquid at an elevated temperature but below the lower threshold temperature. On the one hand, it may be advantageous when the elements to be treated are already at a temperature close to the smoothing temperature. On the other hand, it has been found that pre-treating elements at a temperature below the lower threshold temperature with either the treating liquid or with water or with a mixture of water with a lower amount of alcohol may be advantageous so that the surface of the elements is saturated with water. This may increase the buffering function of the water during smoothing, i.e. delay a reaction which otherwise would proceed too quickly or could destroy the elements.

Without being bound by a theory, it is assumed that particularly advantageous results may be achieved if the treatment or smoothing lies in the range of the crystallization temperature of the polymer, or beyond.

The smoothing process and the quality of the elements obtained may in many cases be further optimized by a preheating step, by monitoring and controlling the cooling time and optionally by post-treatment.

As soon as the temperature is above the lower threshold temperature, the smoothing process starts, slowly at first and then becoming very quickly as the temperature approaches the upper threshold temperature. The period to keep the elements in contact with the treating liquid at a temperature between the lower threshold temperature and 1° C. to 15° C. below the upper threshold temperature depends on the heating rate and may be adjusted. Preferably, this may be maintained over a period of 1 second to 20 minutes.

Smoothing takes place very quickly near the upper threshold temperature. Therefore, the period to hold the elements in a temperature range between 2° C. and 0.5° C. below the upper threshold temperature should be in the range of up to 3 minutes, preferably 5 seconds to 2 minutes, such as for example 10 seconds to 1 minute. The smoothing time depends on the wall thickness and the element size and is longer for bigger parts and shorter for small parts. The period also depends on the heating rate during heating. The treatment or smoothing period may be up to 30 minutes, for example 1 second to 15 minutes, and is preferably approximately 20 seconds to 10 minutes. The higher the heating rate, the shorter the treatment or smoothing period may be.

Furthermore, it was found that bringing the elements to be treated into contact with water or with the treating liquid in a pre-treatment step at temperatures between 20° C. and 150° C., preferably between 80° C. and 130° C. and periods between 15 minutes and 24 hours may improve the treatment results or smoothing results.

Another parameter of the method is the heating rate of the elements in step a) and/or step b).

In step a), heating is not critical and many variants are possible. The heating rate in smoothing step b) is more critical, if there is one, as it has an influence on the smoothing time and the quality of the elements. Typical heating rates when heating elements in or together with the treating liquid, i.e. preferably in the smoothing step b), are 0.1° C./min to 30° C./min, preferably 0.5° C./min to 10° C./min, such as 1° C./min to 5° C./min.

Once the smoothing period is completed, the elements are optionally cooled in step c).

In several embodiments, heating is carried out in the smoothing step b), e.g. from approximately the lower threshold temperature (or below) to a desired temperature value that is below the upper threshold temperature.

In several embodiments of the method according to the invention, in the cooling step c), the polymer elements are cooled down to a temperature of at least 5° C. below the upper threshold temperature, preferably to a temperature below the lower threshold temperature. Thereby, the cooling rates may be 0.1° C./min to 30° C./min, preferably 0.5° C./min to 10° C./min, such as 1° C./min to 5° C./min.

According to a preferred embodiment of the present invention, in cooling step c), the treating liquid containing the smoothed polymer elements may be cooled for a period from 1 minute to 48 hours and/or the treating liquid may be at least partially replaced by a cooling fluid, wherein the cooling fluid is preferably water.

In general, it was found that when using the treating fluid of the present invention, the temperature range for smoothing is between 50° C. to 320° C., such as 120° C. to 180° C. A preferred temperature range is 100° C. to 190° C.

After treatment, the elements may be removed from the chamber and dried or functionalized in a further step.

Drying may be achieved by storing the smoothed elements in a furnace or drying box, possibly using devices such as a fan or other known devices to remove any remaining treating liquid. The drying time is not critical and may range from approximately 5 minutes to hours or even days such as 1 to 24 hours. Alternatively, or in temporal combination, drying may be carried out also in a vacuum furnace and/or in a negative pressure chamber with or without additional heat input and/or with a circulation device. Such devices may be part of the apparatus according to the present invention.

In several embodiments, at least one functionalizing agent is applied to the polymer elements during or after treatment with the treating liquid in at least one step of the method.

In some embodiments, at least one functionalizing agent is applied during or after step c), wherein the method preferably further encompasses a step d) for functionalizing the treated and/or smoothed polymer elements by applying at least one functionalizing agent.

In several embodiments, devices for driving or manipulating the treating liquid and/or the functionalizing agent are used during at least one of the steps a) to c) and/or during the functionalizing step d), wherein the driving device is preferably at least one impeller, a propeller, a stirrer, a swirling device, a pump, a nozzle, a jet nozzle, a pulsator, an electromagnetic apparatus, a vibration unit and/or a sonic or ultrasonic unit.

In some embodiments, the functionalizing agent comprises at least one agent selected from a colorant, a dye, a pigment, a fiber, a curing agent, a metal powder, a ceramic powder, a titanium dioxide, a polymer powder (preferably a polyamide powder, a polypropylene powder, a TPE powder, a TPU powder, a TPA powder, a TPC powder, a TPO powder, a PET powder, a PETP powder, a PBT powder, a PS powder, a PMMA powder, a POM powder, a PK powder, a PTFE powder, a PFA powder, a PVDF powder, a PPS powder, a PEI powder, a PSU powder, a PESU powder, a PPSU powder, a PEEK powder, a PEKK powder, a PEK powder, a PEAK powder, a PI powder) an inorganic pigment or powder, a hydroxyapatite, a calcium phosphate, a bioactive ceramic, an electrostatic discharge agent, a filler, nanoparticles, nanofibers, textile fibers, a base, an acid, a buffer system, an oil, a salt, a finishing agent and/or a plasticizer.

In several embodiments, a colorant or dye solution is applied in the functionalization step d).

In some embodiments of the method according to the present invention, the polymer elements have been obtained by a sintering/melting process, such as for example a multi-beam melting process, a multi-jet fusion (MJF) process, a laser sintering (SLS) process or a high speed sintering (HSS) process, a binder jetting process, a ceramic or metal binder process, a light-based process such as SLA, DLP, polyjet or multi-jet, an extrusion process such as fused deposition modeling (FDM) or fused filament fabrication (FFF) or a granule extrusion process.

In several embodiments, the polymer of the polymer elements is selected from a polyamide-based polymer or copolymer, a thermoplastic elastomer such as thermoplastic polyurethane (TPU), thermoplastic polyamide (TPA), thermoplastic copolyester compound (TPC), or thermoplastic styrene block copolymers (TPS), such as styrene/ethylene/butylene/styrene block copolymer (SEBS) or acrylic polymers such as acrylonitrile-butadiene-styrene (ABS), acrylic ester-styrene-acrylonitrile (ASA), polyketone (PK), polypropylene (PP), polyethylene (PE) or one of PMMA, PS, POM, PC, PEI, ULTEM9085, PSU, PESU, PPSU, PPS, PEK, PEAK, PEEK, PEKK, PVDF, PFA or polybutylene terephthalate (PBT) or a copolymer or a mixture thereof.

In some embodiments, the polymer of the polymer elements is a polyamide selected from an aliphatic, semi-aromatic or aromatic polyamide, such as polyamide 12 (PA12), polyamide 6 (PA6), polyamide 6.6 (PA6.6), polyamide 11 (PA11), PA 4.6 (PA4.6), polyamide 612 (PA612), polyphthalamide (PPA); a thermoplastic polyamide or copolyamide or a blended or filled polyamide or copolymers, mixtures or mixtures thereof.

In several embodiments of the method, the treating liquid is applied until the surface roughness of the polymeric elements is reduced by between 1 μm and 20 μm.

In some embodiments, the surface roughness may have Ra values between 1 μm and 7 μm, such as between 2 μm and 5 μm, after the treatment according to the present invention. In certain embodiments, the surface roughness may have Ra values below 2 μm, such as below 1 μm, after the treatment according to the present invention.

It has been found that particularly high-quality and smooth surfaces can be achieved with a treating agent comprising alcohol and water, such as ethanol and water, and possibly the addition of at least one further treating agent, if the alcohol content is high to very high. Thus, the method according to the present invention for treating elements may take place in certain apparatuses according to the present invention at very precise and stable parameters, such as for example for temperature, time and pressure and optionally supplementary forms of energy such as circulation, with alcohol contents above 70% by weight, preferably above 75% by weight, such as for example between 80% by weight and 99% by weight. Treating agents consisting of alcohol and water and, if required, at least one further treating agent, preferably as listed herein, with an alcohol content, preferably an ethanol content, of at least 75% by weight lead to particularly smooth and solid surfaces if the suitable upper and/or lower threshold temperature is precisely adhered to in connection with advantageous heating rates and cooling rates. The whitening that preferably accompanies this may also be particularly intense and reach particularly deep into the surface. Advantageously, in certain apparatuses, preferably those with large chamber volumes such as for example over 20 liters and preferably over 40 liters total volume, having treating agents consisting of alcohol and water and possibly at least one further treating agent, an alcohol content, preferably an ethanol content, of approximately 80% by weight to approximately 99% by weight, such as approximately 85% by weight, 90% by weight, 95% by weight, 97% by weight or values in between, may be used. It has surprisingly been shown that when treating elements according to the present invention with treating agents consisting of at least one alcohol and water such as, e.g., at least ethanol and water with or without the addition of further treating agents, at high to very high alcohol contents, such as for example alcohol contents above 70% by weight, the properties of the surface texture and surface quality of elements may be particularly advantageously improved, for example, in that the uniformity of the smoothing over the entire surface is very well formed and/or the desired surface roughness can be set very precisely, preferably within Ra value tolerances of 3 μm, particularly preferably of 2 μm, such as for example with tolerances within 1 μm. In this, the tolerances preferably refer to surface areas of elements that have similar or relatively similar geometries and/or wall thicknesses. In this respect, for example, internal surfaces should preferably not be compared with external surfaces, or bores or internal channels should not be compared with fine webs or external cylinders.

Treating polymer elements using the method of the present invention may be carried out in any suitable apparatus.

For example, the polymer elements may be treated in an apparatus as claimed in the present application and as shown in FIG. 1, which comprises a chamber or process chamber with an optional cover, at least one inner container for receiving the polymer elements and the treating liquid, and devices for controlling the temperature, wherein the apparatus preferably further comprises at least one of a circulation device, a heating device and/or a coolant tank comprising a cooling fluid. This device is described and explained in more detail below and in the example.

In order to apply a water-alcohol mixture, for example a water-ethanol mixture, and/or optionally a pure alcohol or a denatured alcohol, a chamber, such as a pressure vessel, may be used.

The chamber may be equipped with a lowerable platform for positioning the elements. The elements may be arranged in any possible form, for example, the elements may be suspended under the platform using suspension devices and/or may be arranged on a platform, for example as bulk material in a perforated or slotted container or on a grid. Options for component-specific storage or the different clamping and suspension variants are described below. The advantage is that using a treating liquid of the present invention allows the elements to optionally move or flow among each other and they may be treated without sticking to each other.

To circulate the treating liquid, it may be useful to use a stirring device such as a distributor, an impeller, a turbulator, a pump and/or a nozzle such as a jet nozzle.

In a preferred embodiment, the platform with the elements remains in the treating liquid during the set process time.

Several embodiments of the present invention are outlined above and/or below.

Any described step may be combined with other embodiments as long as there is no contradiction and the context permits it.

It is also possible to supply liquids to one or two containers within the chamber.

These containers are preferably open at the top. One liquid is, for example, the treating liquid for smoothing the elements at elevated temperature, such as a water-ethanol mixture. The second liquid may be a process-inhibiting agent or mixture or an inert solvent such as glycerol, glycol or water or a functionalizing agent such as a colorant or dye or a fluidized powder or fibers or the like. Dispersed solutions of water and/or treating agents with powders, particles, fibres and/or nanoparticles such as nanotubes are also suitable for this purpose. A mechanical manipulator such as a gantry crane can be provided to transport the elements between the two containers in accordance with the process description.

It has been found that by controlling the process temperature and process time, depending on the treating agents and concentrations used, mechanical or dynamic properties such as the strength or stiffness of polymer elements treated by the method of the present invention may be changed and/or ameliorated in a controlled manner. Such process control may also effect the micro surface or the options for post-treatment processes. Such targeted and permanent modifications, changes and/or adjustments to the properties of elements can be achieved particularly preferably with treating agents according to the present invention having an alcohol content, such as an ethanol content above 80% by weight, and in very specific embodiments also with pure or almost pure alcohol such as for example pure ethanol.

Thus, a matt surface with low or very low surface values may be produced through corresponding process control.

In the post-treatment of the elements, such as coating, printing, labeling, electroplating, galvanizing, bonding or other post-treatment steps, a process carried out in this way may provide advantages in terms of adhesion or layer adhesion by, among other things, optimizing or adapting the surface tension and/or the surface size of the polymer element surface for the respective process.

In most cases, an element is treated with treating liquid in such that the entire surface comes into contact with treating liquid and is thus preferably smoothed.

If only a part or a section of an element is to be treated and/or smoothed, then preferably only this part may come into contact with the treating liquid, at least for a longer period. This may be achieved by at least largely excluding said part of the element which is to remain untreated from contact with the treating liquid and/or by protecting it from contact with the treating liquid, for example by applying a protective layer to said part of the element that remains untreated, for example by applying a layer such as a wax layer or a silicone layer, in particular a removable layer.

Smoothing, dyeing and functionalization of elements may be carried out simultaneously or independently in any order and also repeatedly, which advantageously makes the method according to the present invention very versatile.

In one embodiment, elements are first treated and/or smoothed and then dyed and/or functionalized, in another embodiment, elements are first dyed and/or functionalized and then treated and/or smoothed. Dyeing and/or functionalizing may be performed in the same process line as smoothing, or elements may be smoothed, stored and dyed/functionalized separately if desired or required. Thus, dyeing, functionalizing and smoothing may be carried out independently of each other.

Elements, in particular white elements, treated according to the method of the present invention have a smooth surface which may be dyed using conventional dyeing methods. These elements may be dyed in many different shades due to their smooth and white surface, which has not been densified by mechanical treatment.

If a powder-based manufacturing process has been used for producing the elements, a significant advantage of the method provided by the present invention is that the surface is preferably smooth and contains no or hardly any powder, since any powder remaining on the surface after additive manufacturing is removed or melted or fused by the treatment according to the present invention. In other words, elements that often still have large amounts of residual powder on the component surface due to immediate post-treatment steps such as blasting may have at least most of this powder residue permanently removed using the method and/or apparatus according to the present invention. Particularly preferably, the method causes the elements to be completely freed from powder residues. This may apply in particular to elements which are used in special areas, such as for example use in the medical field, in which the retention of powder residues on the component surface, as is known from the prior art, is unacceptable.

A further advantage is the mechanical strength, in particular the fatigue strength of the elements treated according to the present invention. For example, the tensile strength, the compressive strength and the flexural strength of elements may partially be significantly increased both statically and dynamically and dynamically alternately.

Without being bound by any theory, it is assumed that by treating elements with the method of the present invention, boundary stresses are reduced and molecular chains are rearranged or restructured, resulting in a smoother and/or stronger surface.

The method of the present invention enables not only the smoothing but also the functionalization of elements in order to change or improve their properties such as gloss, texture, mechanical strength, electrical properties such as electrostatic charge, surface tension, biocompatibility, etc.

This is achieved, for example, by contacting the elements with a functionalizing agent together with the treating liquid or directly after treatment with the treating liquid while the surface of the element is still soft.

A functionalizing solution or a functionalizing agent may either be applied to the element together with the treating liquid or to the element obtained after application of the treating liquid.

A functionalizing agent is any agent that gives the surface positive properties such as appearance, color and/or texture.

A functionalizing agent may provide for a hard and/or glossy surface or for a softer surface, for a deep black surface, for a grey or white surface or a surface in a desired color shade, for a surface preferably flocked with textile fibres, for a special surface structure, for a metallized surface that may optionally be galvanized, such as for example post-galvanized or copper-plated, i.e. a priming layer for galvanizing or copper-plating, for a biocompatible surface, for an osteoinductive surface or for a surface that avoids electrostatic charging. The functionalizing agent may also comprise fibres, powders or other reinforcing agents which may result in either a reinforced layer and/or a textured layer and/or a softer or even fluffy layer and/or other positive properties of surfaces and/or elements. Functionalizing agents may either be dispersed and/or dissolved in fluids such as water or aqueous solutions or in treating agents according to the present invention, or they may be applied directly to elements without additional fluids, for example by fluidized beds, by flocking, by spraying or by other methods known to the skilled person. It is also possible to use a plasticizer as a functionalizing agent in order to ensure a smooth and soft surface. Oils and salts may also be used as functionalizing agents. These functionalizing agents may be used as known to the skilled person, i.e. in concentrations, at temperatures and in time periods usually used for such agents. The method of the present invention enables using such functionalizing agents and providing functionalized surfaces in a simple manner. Thus, the method of the present invention is very versatile and enables the creation of different surfaces, in particular also for medical applications as well as for aerospace and aviation applications.

For application, the functionalizing agent may either be dissolved and/or dispersed in the treating liquid, optionally containing water and at least one alcohol and possibly an additional solvent, or dissolved and/or dispersed in another solvent and applied together with the treating liquid.

It is also possible (i.e. encompassed by the present invention as an embodiment) to apply the functionalizing agent in pure form (i.e. without additional fluid in different aggregate states) and/or a solution and/or a dispersion of the functionalizing agent in all possible aggregate states, preferably in liquid state shortly after the smoothing step, for example within 1 second to 60 minutes after the smoothing step, such as 1 minute to 20 minutes after the smoothing step. It is also possible to apply a functionalizing agent in powder form, either dispersed in the treating liquid or as a separate dispersion together with the treating liquid or after application of the treating liquid, while the surface of the element is still altered, activated, soft and/or sticky.

It has been found that when using a powder, for example a metal powder, it is possible to use a nebulization chamber or evaporation chamber with a microwave unit and/or an ultrasound unit and/or a magnetic manipulation unit and/or an electromagnetic manipulation unit and/or distribution devices such as propellers, fans, impellers and/or blowers for the contacting step with solvent vapor. Such evaporation chamber may optionally be a negative pressure chamber, which is advantageously equipped with a vacuum pump. Such an evaporation chamber may optionally be a positive pressure chamber and/or equipped with at least one heating device.

In particular, metal powders with particles in the nanometer range can be distributed in high density and with high uniformity by microwaves and/or ultrasonic waves and/or magnetic fields and/or by distribution devices such as propellers or impellers. Microwaves, and/or ultrasound waves and/or magnetic field apparatuses and/or distribution devices such as propellers or impellers ensure that the resulting vapor treats the surface and distributes the functionalizing agent very uniformly. Another possibility is to apply functionalizing agent together with or after treatment with treating agent in liquid/dissolved/dispersed form. For example, the functionalizing agent may be provided in liquid state in a container and the elements may be dipped therein. The stated distribution arrangements may also be used here. Particularly preferably, in such an embodiment of the present invention, functionalizing agents may be distributed by a pump and/or a stirrer and/or by jet streams as uniformly as possible or optionally in a targeted manner and possibly kinetically strongly accelerated and thus applied to and/or introduced into the elements.

Since the method of the present invention may result in elements having a smoothed surface without at least significantly densifying the surface layer, these elements may be dyed with good results using acid dyes, dispersion dyes, sulfur dyes or other dyes known for dyeing polymers.

Preferably, the element is removed from the apparatus and dried after completion of the treatment steps a) to c).

Any remaining liquid should be removed and the polymer element may be dried as known to the skilled person, for example, by simply leaving the polymer element exposed to air or by heating, using an air stream or jet stream or any other devices commonly used for drying polymer elements, such as for example a vacuum furnace.

With the treatment according to the present invention, the elements may be smoothed in order to reduce the roughness preferably by up to 15 μm, such as 5 μm to 10 μm, so that the roughness after the treatment is for example in the range of up to 10 μm, such as 0.5 μm to 6 μm, for example 0.7 μm to 4 μm. According to a preferred embodiment of the present invention, the treating liquid may be applied until the surface roughness of the polymer elements is reduced by 1 μm to 20 μm.

A further reduction in roughness may be achieved by more than one treatment cycle or run and/or by combination with other methods known to the skilled person.

The smoothing effect may be achieved with or without mechanical pre-treatment. In addition, the method according to the present invention has further advantages in that the steps may be easily performed and may be at least partially automatized.

In a further embodiment of the present invention, a mechanical step may be carried out after the treatment of elements with the treating liquid while the surface of the elements is still soft.

In several cases, treatment with plastic beads, ceramic beads, metal beads or glass beads (or other blasting media described herein) or with a jet stream and/or with open air plasma may further smoothen and/or modify the surface.

The method of the present invention may optionally comprise a further step—a post-processing step in which elements that have been subjected to treatment with a treating liquid are brought into contact with a post-processing composition, which may be a colorant, such as for example water or an aqueous solution, immediately or up to 60 minutes after the treatment, in certain embodiments up to 48 hours after the treatment, preferably within a period during which relevant amounts of at least one treating agent are still present on and/or in the surface. A post-processing step may also be carried out in a non-aqueous treating agent and/or contain very small amounts of colorants, such as for example below a concentration of 0.2%, preferably below 0.1%. The temperatures for a post-treatment step may be between 5° C. and 135° C., preferably between 40° C. and 120° C., such as between 60° C. and 95° C., and may vary during the treatment.

Glycols, i.e. dihydric alcohols, may preferably be used for smoothing polyamides and polyamide copolymers such as PA12, PA11, PA6 and thermoplastic elastomers TPU and TPA (others also possible).

In some embodiments, the treating liquid comprises, or consists of, a mixture of glycol and water, such as propylene glycol and water, for example in the ratios mentioned herein for the ethanol-water-mixture.

In some embodiments, the treating liquid comprises, or consists of, a mixture of propylene glycol and triethylene glycol or propylene glycol and polyethylene glycol. Other, or further glycols, acting preferably passive or less reactive on the surface of the elements at the same treatment temperatures, or similarly acting agents, i.e. preferably inactive substances, may also be used for or as the treating liquid.

The advantage of using treating agents such as at least one glycol as a complete or partial replacement for e.g. ethanol and/or water, is the higher boiling point of the treating liquid or the individual ingredients of the treating liquid, which lies preferably above the treatment temperature in smoothing step b) (for example up to 170° C.). In this way, a complex pressure vessel is not required in certain cases. The method according to the present invention and/or its smoothing step b) may be carried out in an open chamber or in a chamber that is not necessarily pressure-tight, respectively.

The (glycol) methods described may all be combined with the granular media in the treating liquid already described. Such granular media as an additive in the treating agent may serve as a separator during smoothing and/or for microstructuring and/or for an enhancing or inhibiting effect of a reorientation of carbon black or soot within the surfaces and/or for an additional, mechanical smoothing process.

In several embodiments, the treating liquid and/or the functionalizing agent is or will be introduced, prior to the treatment, into a container, e.g. in a type of capsule, preferably in the required amount for a treatment. The capsule is placed in the chamber, as are the elements. The capsule may be opened for the treatment, for example using a mechanical or magnetic manipulator, so that treating liquid and/or functionalizing agent may distribute within the chamber and possibly together with another treating liquid within the chamber.

In a preferred embodiment, several containers, e.g. capsules with possibly different amounts of treating liquid, are present in the chamber or in fluid communication therewith. In this way, the treatment, smoothing and/or functionalization may be carried out in several steps one after the other, in a pulsed manner so to speak. The capsules may not only contain different types and/or amounts of treating liquid, but these different treating liquids and/or amounts may have different temperatures, which may also apply if the treating liquids and/or amounts should be the same.

Water or an aqueous treating agent may be used to cool or otherwise stop the treatment and/or smoothing. This may be provided, for example, in one of the containers or capsules mentioned herein.

In some embodiments of the apparatus according to the present invention, the apparatus is prepared for carrying out the method according to the present invention.

In some embodiments, a container for additives is placed in the chamber of the apparatus according to the present invention.

In some embodiments, the container for additives is filled with dyes (e.g. liquid or as powder), pigments, functionalizing agents (e.g. as powder or with fibers) and/or additives.

In several embodiments, a reservoir containing preferably thermally identical, warmer or colder treating liquid is in fluid communication with the chamber of the apparatus according to the present invention, or the apparatus is prepared accordingly.

In certain embodiments, the reservoir may be or will be filled with warmer or colder treating agent, e.g. by 5°, 10°, 15°, 20° C. or more, for faster heating or cooling in the chamber, also referred to herein as the main chamber. Alternatively or additionally, it may be in communication with a circulation pump and/or pressurized.

During smoothing, preferably of bulk material, the treating agent in the chamber is preferably brought to the treatment temperature within an upper or maximum heating rate. This occurs, for example, at 0.1° C./min up to 5° C./min. In certain embodiments, the increase in temperature is not or not approximately linear over the entire temperature range of the heating phase, rather the heating rate is increasingly reduced, especially in the upper temperature range for technical reasons. If the heating rate should be made faster, preferably in an upper temperature range (e.g. over 100° C.), then additionally stored treating agent from a reservoir, which has been brought to a higher temperature in advance such as for example between 120° C. and 220° C., may be introduced into the chamber from a certain temperature during circulation by a circulation pump, or at least be partially exchanged by circulation in this way. Thus, the treating agent may be heated much faster and special surface properties or effects may appear on the elements. The treating agent introduced may contain different treating liquids and/or concentrations than the treating agent in the chamber with the elements or at least be designed in approximately the same way.

Conversely, during cooling down (preferably directly at or immediately after the upper temperature inflection point), colder treating agent may be brought into the chamber from the reservoir by circulation. In this way, the treating agent may be cooled down more quickly in the upper (critical) temperature range. The treating agent introduced may contain different treating liquids and/or concentrations than the treating agent in the chamber with the elements or may be the same or at least approximately the same.

The method described can preferably be combined with other methods for heating or cooling down, respectively. For example, during cooling down, in addition to the solution just described, cooling hoses on the chamber wall, preferably on the outside of the chamber wall, may provide an additional cooling effect. During heating, heating pipes or heating hoses, preferably on the chamber wall, preferably on the outside of the chamber wall, may ensure optimum heating. Heating and cooling systems for the thermal supply of the chamber wall, such as pipes or hoses, may be a single unit. In other words, heating water or cooling water may be transported alternately through the same pipes or hoses in order to control the temperature in the chamber.

In some embodiments of the apparatus, the fluid communication is in functional communication with a circulation pump and/or a device for pressurization.

In several embodiments, the reservoir is or will be filled with treating agent that has been preheated to or beyond the predetermined treatment temperature. The elements are stored in the main chamber. For smoothing, the preheated treating agent or at least part of it is guided or conveyed from the reservoir into the main chamber. This may be done in various ways, for example by using at least one pump (for suction or pressure) and/or by applying pressure (compressed air/inert gas) in the reservoir and/or in the main chamber. In certain embodiments, the pressures may be specifically adjusted and/or pulsed in this way, i.e. pressure fluctuations between the chambers or containers may be provided, for example to accelerate the detachment of residual powder from the components or to achieve certain patterns or effects on the surface of the elements.

In some embodiments, cooling is preferably provided by at least one built-in cooling helix, cooling surface or the like.

In several embodiments, a colder treating agent is forced into the chamber by pressure. In these embodiments, either the internal pressure continues to rise, or the rising pressure in the chamber is continuously released via a valve or pressure relief valve, preferably into at least a third chamber.

In some embodiments, before treating agent is introduced into the chamber, a smaller amount of water is optionally added to the chamber and preferably heated to approximately the upper treatment temperature. The water will evaporate from about 100° C. and thus wet and infiltrate the polymer elements with water vapor, wherein the water may serve as a protective medium during subsequent smoothing and in this way, for example, enables filigree structures to be smoothed more reliably.

In some embodiments, the inner container may be fixed in the container, preferably releasably and/or adjustably.

In several embodiments, the inner container is provided to receive the polymer elements within the chamber, in particular to be removable—preferably without tools—from the apparatus, for example upwards.

In some embodiments, the inner container, which may be a basket, is preferably made of stainless steel and/or it is preferably coated with a coating which reduces the adhesion of at least partially melted elements.

Coatings that have an easy-to-clean effect are particularly suitable. They preferably withstand the process temperatures. Preferably, such coatings are made of PTFE, PFA, ceramic, microfinish and/or other materials or polymers that may reduce the adhesion of polymer elements during smoothing.

In several embodiments, the inner container is preferably in the shape of a cylinder.

In some embodiments, the inner container has, particularly preferably, a separation for the polymer elements in the center of the cylinder, for example, in the form of a further cylinder. In other words, such a preferred inner container has approximately the shape of a ring when viewed from above.

In several embodiments, the inner container may be divided into several segments (cake pieces) by arrangements such as e.g. partition dividers or partition walls.

In some embodiments, the inner container is, particularly preferably, manufactured in the center with a geometry which has a driving possibility for a rotational movement with respect to a drive shaft which stands preferably vertical within the chamber.

In some embodiments, the inner container has a diameter to height ratio of approximately 5:1 to approximately 1:1.

In several embodiments, the volume of the inner container that may be used to receive polymer elements is preferably between 10 liters and 150 liters, particularly preferably between 20 liters and 80 liters, such as for example between 30 liters and 60 liters.

In some embodiments, the inner container is designed with a cover, which is preferably provided to completely immerse the polymer elements in the treating liquid after dipping.

In several embodiments, the cover of the inner container is a basket cover.

In some embodiments, the cover of the inner container is particularly preferably designed with geometries or structures which, for example by rotating the inner container, cause a forced flow of the treating agent from top to bottom in order to thus actively push or convey polymer elements, preferably with a low density, downwards within the treating liquid. Such geometries or structures may be, for example, recesses, protrusions and/or machine elements which resemble or approximate the shape and function of propellers.

In several embodiments, the apparatus according to the present invention is provided to receive a plurality of inner containers in a chamber.

In some embodiments, the chamber comprises at least one chamber passage for an axial and/or rotational drive of the at least one inner container and/or for at least one impeller and/or for at least one circulation device and/or for at least one stirring device, preferably for circulating the treating agent and/or for moving or accelerating granular media and/or for driving elements.

In several embodiments, the chamber passage is preferably designed in the form of a circular shaft, which particularly preferably has a diameter of 6 mm to 22 mm, particularly preferably between 8 mm and 22 mm, very particularly preferably between 10 mm and 18 mm.

In certain embodiments, the at least one shaft of the chamber passage is rotationally driven at a speed of preferably 1 rpm to 1000 rpm and particularly preferably between 50 rpm and 300 rpm, preferably by a motor. Preferably, this is accompanied by a rotary movement of the at least one inner container and/or the at least one impeller and/or the at least one circulation device and/or the at least one stirring device, particularly preferably at the same speed as the shaft.

In some embodiments, the shaft-like chamber passage is optionally designed as a pipe, wherein the interior of such a pipe is preferably sealed against increased chamber pressure.

In several embodiments, the chamber passage is designed as a pipe and has at least one further shaft in its center in order to generate a double passage in this way. This embodiment may be advantageous if, in addition to at least one up and down movement of the inner container, a rotational movement of the at least one impeller is to be carried out which impeller is preferably disposed in the axial direction in the vicinity of the container base on its inside.

In some embodiments, a shaft is preferably passed through the chamber bottom from below and at least approximately in the center thereof, and preferably at least approximately coaxially with the chamber wall, which is preferably in the form of a cylinder. Such a shaft preferably comprises a geometry on its upper side which represents a form-fit drive connection with respect to the at least one inner container.

In some embodiments, at least two drive elements are preferably arranged below the chamber bottom, wherein a first drive element provides for an axial movement of the shaft (up and down) and a second drive element provides for a radial rotary movement of the shaft.

In several embodiments, the drive element for the linear and/or axial movement of the shaft is optionally a spindle axis, a scissor lift mechanism, a pneumatic cylinder, a hydraulic cylinder or another machine element known to a skilled person for exerting a linear movement.

In some embodiments, the rotational movement is preferably exerted by an electric motor, which is preferably attached to the axially movable part of the linear drive element.

In some embodiments, the shaft may also be, or will be, inserted into the chamber from above. Preferably, this is the case when a surface treatment is carried out with treating agents the maximum treatment temperatures of which are below the boiling points thereof, particularly preferably at atmospheric pressure.

In some embodiments, the rotary movement of the shaft and of the at least one inner container connected thereto is carried out during the treatment process at different speeds, which alternate cyclically or continuously between a speed of preferably 1 rpm to 500 rpm and particularly preferably between 30 rpm and 250 rpm. In addition, the rotary movement can also be stopped completely, at least temporarily.

In several embodiments, the direction of rotation of the inner container may be reversed cyclically in order to achieve optimal mixing of the treating agent and the polymer elements.

In some embodiments, an up and down movement preferably of the at least one inner container between two or more end points may be carried out simultaneously or alternately to changing rotational speeds and/or rotational directions.

In several embodiments, the speed and cyclic frequency of the up and down movements can be varied.

In some embodiments, the sealing of the shaft with respect to the chamber is preferably designed by shaft sealing rings or O-rings, which are preferably arranged in at least a double row, so that at least a double protection against an escape of treating liquid is effected.

In some embodiments of the apparatus according to the present invention, a magnet duct, e.g. in the center, is provided for moving the inner container, in particular for the rotation thereof and/or its up/down movement. Magnet ducts may, for example, be designed with permanent magnet(s) or electromagnet(s).

A magnet duct may preferably be realized by a pipe which projects into the interior of the chamber in the center or elsewhere, and a magnetic manipulator is placed and/or moved therein.

In several embodiments, the elements may be subject to pre-treatment.

For example, a pre-treatment may be to dip polymer elements in a pre-treatment bath comprising one or more treating agent(s) for a certain time (up to 72 hours has been found to be useful) at a certain temperature, which is preferably below the lower threshold temperature. Pre-treatment with mist or vapor using one or more treating agent(s) at a certain temperature below the lower threshold temperature and for a period up to 48 hours, in certain embodiments even longer, may also be a suitable pre-treatment. The application of treating agent vapor and/or treating agent mist may be achieved within a pre-treatment chamber using, for example, an ultrasound generator (and heat) and/or a swirling device such as a propeller or fan. The effect for pre-treatment by vapor and/or mist may be achieved or intensified by increased temperatures and/or by negative pressure or vacuum within the pre-treatment chamber. If a corresponding pre-treatment of the polymer elements is carried out, it is advisable to carry out the actual smoothing treatment within as short a time period as possible, such as, e.g., within 12 hours, particularly preferably within two hours.

In some embodiments, the treating agent is present as a “mist”.

In several embodiments, a “mist” of at least one treating agent is to be considered as a liquid treating agent, wherein a plurality of similarly shaped and/or uniformly distributed droplets may be distributed and/or moved within a chamber. Mist droplets may have a size up to a radius of approximately 80 μm, preferably a radius between 1 μm and 50 μm, such as for example between 5 μm and 30 μm.

A mist of at least one treating agent may be produced according to the present invention by any method known to the skilled person.

In some embodiments, a mist of at least one treating agent may be generated, for example, by exposure to sound or ultrasound.

In several embodiments, a mist may be generated or formed by a compression and/or acceleration and subsequent expansion of at least one treating agent, for example by a nozzle.

In certain embodiments, a mist may be produced by the two steps 1 and 2, namely 1: evaporation of at least one liquid treating agent preferably by heating it above a boiling temperature and 2. cooling and optionally distributing the vapor from at least one treating agent until mist droplets are formed from the vapor, preferably in the presence of at least one gas and/or by circulating the spreading mist droplets by a circulation device or a swirling device, preferably for exerting linear and/or turbulent flow of the mist droplets, particularly preferably in a temporal or intermittent alternation.

In some embodiments, the elements may be subject to a post-treatment, which preferably serves to bring residual amounts of the treating agent(s) out of the surface of polymer elements or out of the interior of polymer elements, such as for example a thermal and/or vacuum treatment, a treatment with supplementary energy sources and/or by washing with at least one post-treatment solution or one post-treatment gas such as supercritical CO2.

The described post-treatment options may also be combined. In addition, it is advantageously possible to perform a coating step and/or functionalization step before, during or between the post-treatments in a manner as described herein.

Before, during or between the post-treatments, the elements may be subject to mechanical surface treatments. Blasting and/or vibratory finishing may be used in a particularly advantageous manner. Such a treatment by blasting and/or vibratory finishing may cause microstructuring on the at least not yet completely re-hardened or re-cured surface of the polymer elements, which may be permanently visible on the surface after preferably at least one further post-treatment. Such microstructuring thus advantageously effects e.g. grained or matt surfaces. Simultaneously and/or alternatively, the surface roughness may advantageously be further reduced by at least one mechanical post-treatment before, during or between the post-treatments.

In several embodiments, it is planned to preheat the treatment liquid already in the reservoir to the smoothing temperature or above, to arrange the elements in the chamber and/or to increase the pressure in the reservoir, e.g. by compressed air or using nitrogen. In this way, hot treating agent may be displaced into the chamber.

In some embodiments, at least one temperature control device, for example a so-called open temperature control device, is used and may be part of the apparatus. The temperature control device may comprise a heat transfer medium which is different from the treating liquid, e.g. a liquid heat transfer medium for storing thermal energy, e.g. water and/or a heat transfer oil. The temperature control device may be provided to temper, in particular heat, the chamber, the reservoir or other sections of the apparatus.

In several embodiments, two or more chambers are provided for receiving elements. In this way, treating liquid, which is required in both the first chamber and the second chamber, may be pumped back and forth between the two chambers. While the treating liquid in the first of these chambers is used in a smoothing step, the second of these chambers may be loaded with elements. Once the smoothing step has been completed in relation to the first chamber and the temperature of the treating liquid has preferably been reduced to a value below the lower threshold temperature, for example to a temperature between 100° C. and 130° C., the treating liquid may then be pumped out of this chamber and into the second chamber. Smoothing may begin in the second chamber by reheating the treating liquid above the lower threshold temperature, while the elements of the first chamber may preferably be removed from it after a further cooling time of between 5 minutes and 180 minutes, such as between 10 minutes and 60 minutes, and the first chamber may be loaded with new elements. By providing several chambers, the capability or efficiency of such a system may be advantageously multiplied.

In some embodiments, the polymer elements comprise no support section or support element, in particular none that is fabricated integrally or in material-fit manner, in particular one that must be or is usually removed from the polymer elements before they are used.

If nothing is further described herein, then quantity ratios, such as for example those of treating agents or mixtures of treating agents, refer to weight specifications of the individual media or substances or percentage distributions, for example of treating agents, refer to % by weight specifications of the individual substances or media, respectively.

In some embodiments, fatty acids such as for example oleic acid or linoleic acid, preferably saturated fatty acids such as for example caprylic acid or palmitic acid, or mixtures of fatty acids, may be used with each other and/or with other substances or treating agents for treating elements. Treating agents such as oils or fats may also be used, which preferably contain fatty acids in larger quantities, such as for example cocoa butter, shea butter, palm oil or coconut oil. In particular, the treatment with treating agents which contain fatty acids, such as palmitic acid, stearic acid, linoleic acid and/or oleic acid, preferably in larger quantities, may be used for the treatment of polyamides such as PA12, PA11, PA6, PA66, PA6.6, PA46 and polyamide copolymers, as well as for thermoplastic elastomers, such as e.g. TPU, but without being limited thereto.

Fatty acids such as palmitic acid or treating agents containing at least one fatty acid, for example such as palmitic acid, may preferably be, in solid and/or liquid and/or gaseous form, used for treating according to the present invention by, for example, dipping, painting/coating, misting and/or spraying, i.e. preferably by bringing elements into direct contact with the treating agent.

In certain embodiments, the temperature during the treatment of elements with fatty acids, such as for example palmitic acid or stearic acid, or with a treating agent containing at least fatty acids such as palmitic acid or stearic acid, is between 70° C. and 240° C., preferably between 100° C. and 200° C., particularly preferably between 115° C. and 190° C., such as for example between 125° C. and 185° C., at least temporarily or during the predominant period of contact.

In some embodiments, the temperature during the treatment of elements made of or with PA11 with fatty acids, such as palmitic acid or stearic acid, or with a treatment agent which contains at least fatty acids such as palmitic acid or stearic acid, is between 150° C. and 200° C., preferably between 165° C. and 190° C. and particularly preferably between 170° C. and 185° C., such as between 174° C. and 182° C., at least temporarily or during the predominant period of contact. In this, a reduction in surface roughness may occur in an element formed from PA11 or with PA11 constituents with preferred treatment periods of between 5 seconds and 60 minutes, preferably between 20 seconds and 20 minutes, such as for example between 1 minute and 10 minutes.

In several embodiments, the treating agent may consist of at least one fatty acid, such as for example palmitic acid or oleic acid, and/or at least one glycol, such as for example propyleneglycol or triethylene glycol, and/or at least one oil, such as sunflower oil or rapeseed oil, and/or at least one dye, such as for example a disperse dye, sulfur dye or acid dye, and/or at least one functionalizing agent, or it may comprise this composition.

Dyes may preferably be present in concentrations of up to 10% by mass in the treating agent, such as for example between 0.01% by mass and 2% by mass, particularly preferably between 0.1% by mass and 1% by mass.

In some embodiments, the treating agent may contain glycols, such as for example propylene glycol or triethylene glycol, and/or glycerol and/or fatty acids, such as for example palmitic acid or stearic acid, and/or oils, such as for example rapeseed oil or sunflower oil, and/or further treating agents, such as dipropylene glycol or tripropylene glycol, and/or plasticizers, additional solvents, functionalizing agents or ingredients, with or without dye or dyes, such as for example disperse dyes or acid dyes.

In some embodiments, the treating agent may additionally or alternatively comprise at least one acid, such as for example citric acid, malic acid, acetic acid, tartaric acid, phosphoric acid, oxalic acid or further acids.

In some embodiments, the treating agent may additionally or alternatively contain at least one salt, such as for example sodium chloride, and/or at least one filler, such as for example graphite powder or titanium dioxide and/or nanomaterials such as carbon nanotubes; graphenes or fullerenes and/or pigments.

In some embodiments, treating agents having a fatty acid, such as for example palmitic acid or stearic acid, and/or glycols, such as propyleneglycol or triethyleneglycol, may advantageously only be used for coloring by the addition of dyes, such as disperse and/or acid dyes, and not—or to a large extent not—also for smoothing.

Surprisingly, it was found that coloring may be done, preferably at temperatures below 100° C., by combining treating agents with at least one glycol, such as propyleneglycol, and/or fatty acids, such as palmitic acid, and at least one dye, such as a disperse dye or acid dye, and possibly the addition of at least one acid, such as for example citric acid or malic acid, and possibly the addition of at least one salt, such as for example sodium chloride or potassium chloride, and thereby simultaneously the dye may penetrate deep into the surface of the elements, i.e. in this way a strong and intensive dyeing may be realized with less energy input than according to the prior art. The advantage of this may be that only coloring and no, or no significant, smoothing of the surface occurs.

In some embodiments, the coloring and/or functionalization of elements with the aforementioned treating agents may be carried out at temperatures of 100° C. or above, such as for example between 100° C. and 150° C., or in certain applications up to 180° C. or even above. A surface treatment and/or coloring of elements with the combination of fatty acids, such as palmitic acid, and, for example, at least one disperse dye or acid dye, can preferably be carried out between 80° C. and 180° C., particularly preferably between 100° C. and 165° C., such as for example between 115° C. and 155° C., depending on the mixing ratio, exposure time and material of the elements.

Typical exposure periods or contact periods within the mentioned temperatures may be up to 6 hours, preferably between 5 minutes and 240 minutes, particularly preferably between 10 minutes and 150 minutes. Elements for coloring with fatty acids and at least one acid dye may preferably be formed from, or contain, polyamides such as PA12, PA11, or thermoplastic elastomers such as TPU, TPC or TPA.

In certain embodiments, elements may be subject to at least one mechanical post-treatment step, such as for example blasting, grinding, vibratory grinding and/or polishing, before and/or after coloring and/or after smoothing with at least one fatty acid and/or at least one glycol and/or at least one dye.

In some embodiments of the present invention, elements containing polyketone (PK) may advantageously be treated, modified, functionalized, colored and smoothed on the surface in a particularly gentle and efficient manner according to the present invention. Elements made of or with polyketone may be produced using various additive manufacturing methods such as for example material extrusion or a powder bed method such as a selective laser sintering method. Polyketone comprises very good chemical resistance to many media and solvents. Surprisingly, it was found that elements made of or having polyketone may be treated from a temperature of approximately 110°, preferably from 130° C. and particularly preferably from 145° C. with a treating agent made of benzyl alcohol, or at least containing constituents of benzyl alcohol, and a positive change in the surface properties may occur. In particular, by bringing elements made of or containing polyketone into contact with benzyl alcohol at temperatures between 130° C. and 210° C., preferably between 135° C. and 190° C. and particularly preferably between 145° C. and 170° C., a significant reduction in surface roughness can be achieved. Bringing elements, which at least partially consist of polyketone, into contact with the treating agent benzyl alcohol or a treating agent which preferably contains at least 30% by mass benzyl alcohol may be done with all or for all known types of surface treatment. Thus, benzyl alcohol or a treating agent which preferably contains at least 30% by mass benzyl alcohol may be used, for example by spraying, misting, dipping, brushing and/or painting/coating, in order to treat elements made of polyketone, preferably at the above-mentioned temperatures.

It has been surprisingly found that there is no or almost no decomposition or chemical change of the surfaces or no such change will occur to the elements which are at least partially or entirely made of polyketone (PK) when using a treating agent containing at least 30% benzyl alcohol, preferably at least 50% benzyl alcohol and particularly preferably at least 80% benzyl alcohol, as well as when treating with pure benzyl alcohol according to the present invention. This was observed at both high or relatively high treatment temperatures and longer treatment periods, such as for example over 1 minute or over 3 minutes, as may be advantageously the case and/or even a prerequisite for the claimed methods.

In some embodiments, elements which are made at least in part of polyketone may be treated according to the present invention by a mist and/or vapor process, preferably in a chamber with prevailing negative pressure or vacuum.

In some embodiments, in mist and/or vapor processes, i.e. treatments of elements in which the treating agent is at least partially and/or temporarily in mist and/or vapor state, there may be an overpressure within the treatment chamber, measured relative to the ambient pressure, such as up to 2 bar. In certain embodiments, the gas or residual gas within the treatment chamber may for example be air or contain air; in other embodiments, the gas or residual gas may for example be a protective gas such as nitrogen or contain at least one such gas. The combination or a time sequence of at least one spraying or dipping process and at least one mist or vapor process (also in reverse order) for treating elements made of or containing polyketone (PK) with treating media containing at least benzyl alcohol corresponds as well to several embodiments according to the present invention.

In certain embodiments, benzyl alcohol, as the treating agent according to the present invention, may be replaced or supplemented by propylene carbonate, by citric acid triethyl ester and/or by N-cyclohexyl-2-pyrrolidone (CHP) and used according to the embodiments just described for the treatment of elements made of or comprising polyketone (PK), wherein preferably up to 30° C. higher treatment temperatures and/or up to 5 minutes longer treatment periods should be used for comparable results.

It has been surprisingly found that certain kinds of thermoplastic elastomers such as TPE, TPU, TPC, TPA or TPO or mixtures thereof may preferably be treated and/or smoothed with similar or the same treating agents as polyketone (PK), wherein it might be that the treatment temperatures and treatment periods need to be adjusted or modified for advantageous results.

In certain embodiments, the treating agent may during the treatment—preferably at least for the most part—be in its liquid state. It may independent thereof preferably comprise at least one monohydric alcohol and preferably less than 20% by mass water, such as e.g. less than 10% by mass water or less than 5% by mass water.

In some embodiments, at least one further solvent in addition to a monohydric alcohol and less than 20% by mass water may be added or will be added to the treating agent, such as for example a dihydric alcohol, a glycol, glycerol, an ester, an ether and/or an acetal, particularly preferably propylene glycol, triethylene glycol, 1,2-isopropylidene glycerol and/or 3-methoxy-3-methyl-1-butanol. Treating agents which preferably contain less than 20% by mass water may be used in particular for the surface treatment of elements which contain at least one polyamide such as PA12 or PA11 and/or a thermoplastic elastomer such as TPU and TPA. The temperatures at which there is an improvement in the surface properties of such elements, such as for example a reduction in surface roughness, may be between 80° C. and 200° C., preferably between 100° C. and 170° C. and particularly preferably between 110° C. and 160° C., when using treating media containing less than 20% by mass water. In this, for example, the temperature of a polyamide such as PA12 may be between 120° C. and 165° C., preferably between 130° C. and 160° C. and particularly preferably between 135° C. and 150° C. The treatment periods in which elements made of polyamides such as PA12 are treated within these temperatures may be selected approximately between 5 seconds and 120 minutes, preferably between 1 minute and 60 minutes, for example, between 5 minutes and 30 minutes. In the case of a thermoplastic elastomer such as TPU, for example, the treatment temperature may be between 90° C. and 150° C., preferably between 100° C. and 140° C. and particularly preferably between 110° C. and 130° C. The treatment periods, in which elements made of thermoplastic elastomers are treated within these temperatures, may be selected to be approximately between 1 minute and 240 minutes, preferably between 2 minutes and 120 minutes, such as for example, between 5 minutes and 45 minutes.

In certain embodiments, elements made of polyether ketones or containing at least one polyether ketone, may be treated with a treating agent comprising at least one cyclohexyl-2-pyrrolidone (CHP). Preferably, cyclohexyl-2-pyrrolidone (CHP) may be applied in liquid state and/or in the form of mist and/or vapor to elements made of or containing polyether ketone and, thereby, lead to an improvement of the surface properties such as, for example, a reduction of the surface roughness, wherein the treatment temperatures should preferably be above 170° C., particularly preferably above 200° C. such as for example above 220° C. Preferred temperatures for treatment with cyclohexyl-2-pyrrolidone (CHP) may be above 250° C. for certain polyether ketones, for example, between 260° C. and 300° C.

Preferred polyether ketones may be selected from, but are not limited to, the following: PEEK, PEK, PEKK, PEAK. In certain embodiments, elements made of or with polyether ketones may be reinforced with fillers such as, for example, carbon fibers or with graphene.

In some embodiments, elements consisting at least in constituents of a thermoplastic polyurethane (TPU) from the company Lubrizol Corporation under the brand name ESTANE® may be treated. It was surprisingly found that elements which are made of at least in constituents of a thermoplastic polyurethane of the Lubrizol Corporation under the brand name ESTANE® 3D TPU, such as for example under the designation ESTANE® 3D TPU M95A thermoplastic polyurethane (TPU), may be treated with a treating agent which contains at least in section n-butylpyrrolidone and in this way brings about a positive change in the surface properties of such elements, such as for example a reduction in the surface roughness. Preferably, such elements may be formed by an additive manufacturing process, wherein a positive change in the surface properties of the elements preferably has an effect on a reduction of the surface roughness, so that an application according to the present invention with treating agents with at least portions of n-butylpyrrolidone may achieve a smoothing of the surface.

In several embodiments, a TPU under the name ESTANE® 3D TPU M95A may be treated with n-butylpyrrolidone at temperatures between 70° C. and 200° C., preferably between 80° C. and 180° C., and particularly preferably between 90° C. and 150° C., such as for example between 95° C. and 125° C.

In some embodiments, elements made of ESTANE® 3D TPU M95A may be treated, preferably in a chamber with prevailing negative pressure or vacuum, according to the present invention by a vapor process and/or mist process using a treating agent containing at least n-butylpyrrolidone. In some embodiments, in mist processes and/or vapor processes, i.e. in treatments of elements in which the treating agent is at least partially and/or temporarily present in mist and/or vapor state, a positive pressure may prevail within the treatment chamber compared to the ambient pressure, such as for example up to 2 bar. In certain embodiments, the gas or residual gas within the treatment chamber may be, or contain, air, and in other embodiments, the gas or residual gas may be, or at least contain, an inert gas such as nitrogen. Bringing elements which consist at least in parts of ESTANE® 3D TPU M95A in contact with n-butylpyrrolidone or a treating agent containing at least 20% by mass of n-butylpyrrolidone may, thereby, be carried out with all known types of surface treatment. Thus, n-butylpyrrolidone or a treating agent containing at least 20% by mass n-butylpyrrolidone may be used to treat elements made of ESTANE® 3D TPU by spraying, dipping, brushing and/or painting/coating. Thereby, the temperatures may be between 60° C. and 180° C., preferably between 80° C. and 160° C. such as between 90° C. and 140° C. Also encompassed by the present invention is the combination or a time sequence of at least one spraying process or dipping process and at least one mist process or vapor process (also in reverse order) for the treatment of elements made of ESTANE® using treatment media containing at least n-butylpyrrolidone.

In certain embodiments, a thermoplastic polyurethane (TPU) of the Lubrizol Corporation under the brand name ESTANE®, preferably under the trade mark designation ESTANE® 3D TPU M95A may be treated with a treating agent in which n-butylpyrrolidone is replaced or supplemented by benzyl alcohol, by 3-methoxy-3-methyl-1-butanol, by citric acid triethyl ester or by a mixture of propyleneglycol and citric acid triethyl ester. The skilled person may choose the embodiments as described and implemented above for the treatment of ESTANE® with n-butylpyrrolidone. Particularly preferably, adapted temperatures may thereby be used, for example, for benzyl alcohol between 110° C. and 180° C., for 3-methoxy-3-methyl-1-butanol between 144° C. and 185° C., for citric acid triethyl ester and for a mixture of citric acid triethyl ester and propyleneglycol, between 140° C. and 190° C.

In some embodiments, D-limonene may be used as a treating agent for elements. Surprisingly, it has been found that elements made of polypropylene (PP) may display a reduction in surface roughness when treated with D-limonene at temperatures above 80° C., preferably above 100° C., and particularly preferably above 120° C. Such a method may be applied particularly preferably to polypropylene components that have been produced using a powder bed method such as selective laser sintering (SLS), a multi-jet fusion process (MJF) or a high-speed sintering process (HSS). The treatment of polypropylene (PP) with D-Limonene may be carried out with all known types of surface treatment. Thus, D-limonene or a treating agent containing at least 30% by mass D-limonene may be applied by spraying, misting, dipping, brushing and/or painting/coating in order to treat elements made of PP.

In certain embodiments, D-limonene or a treating agent containing at least portions of D-limonene may be heated in the form of mist and/or vapor with elements containing at least proportions of polypropylene at temperatures above 100° C., preferably above 120° C., particularly preferably above 125° C. such as approximately to 128° C. In this, it was surprisingly found that elements treated in this way may be treated with relatively short exposure periods, such as for example between 1 second and 2 minutes, but on the other hand, longer exposure periods of treating agents with D-limonene on elements made of polypropylene, such as between 2 minutes and 60 minutes at the temperatures mentioned, may also have a positive effect on the surface properties and surface roughness.

In some embodiments, elements comprising at least one polypropylene (PP) may not only be made by a powder bed method and treated as described herein, but may consist of other additive manufacturing methods such as an FDM, or an FFF process or by a granule-based extrusion process.

In some embodiments 3-methoxy-3-methyl-1-butanol acetate may be used as treating agent for elements. Surprisingly, it has been found that elements made of polypropylene (PP) may display a reduction in surface roughness when treated with 3-methoxy-3-methyl-1-butanol acetate at temperatures above 80° C., preferably above 100° C., and particularly preferably above 120° C.

In some embodiments of the method according to the present invention, with certain combinations of elements and treating agents at certain pressures and/or at certain temperatures and/or within certain temperature ranges, positive changes in the properties of the elements occur, in particular on and/or within the polymer surfaces, or become apparent without—or almost without—a disadvantageous chemical change in the polymer surfaces being observed, such as decomposition of polymer chains.

In several embodiments, at least two treating agents may advantageously be used and at least one of them may be used as an inactive treating agent according to the present invention.

When reference is made herein to an “inactive” treating agent (also “inactive substance” or also “inactive material” or “inactive liquid”), according to the present invention this term encompasses substances, materials or treating agents which, in combination with at least one further treating agent, under certain conditions, such as at certain temperatures, may act on elements with properties and/or effects which are less intensive or slighter than those of the at least one further treating agent. Inactive substances may also be brought into contact with polymer elements and applied in temporal sequence with the at least one active treating agent. In several embodiments, an inactive substance reduces and/or stops the surface-treating effect and/or surface-changing effect and/or smoothing effect of at least one treating agent, for example at or by falling below a certain temperature and/or at certain pressures and/or by interacting with granular media. An inactive substance is preferably only to be considered or used as such in the specific application and/or for certain materials of the polymer elements and/or under the specific parameters. An inactive substance is therefore always to be understood material-specific and parameter-specific, for example for certain temperatures, and may therefore be considered as an active substance once a certain temperature is exceeded. Thus, in certain embodiments of the present invention, an inactive substance may have at least one of the described inhibiting properties on the surface treatment of elements, but in other embodiments it may be used as an agent for treating and/or changing and/or smoothing elements (for example, in the case of elements made of different materials). Several inactive substances may be used in spatial and/or temporal combination.

Where reference is made herein to “active” substances (also “active treating agent” or “active material” or “active liquid”), this term includes treating agents disclosed herein which may achieve one or more advantageous effect(s) on the surfaces of polymer elements in the context of the method according to the present invention, such as for example an advantageous change in surface properties or a smoothing of surfaces. According to the present invention, an active substance is always in relation to the specific materials of the polymer elements (and possibly their manufacturing method) and namely always depending on certain parameters, which may preferably be temperature, time and/or a pressure, and preferably quite specific combinations thereof.

In some embodiments, the method according to the present invention may be carried out with a physical reinforcement of the effects by supplementary energy sources such as for example electromagnetic induction, pulsations, sound or ultrasound, in other embodiments, without.

In several embodiments, the method leads to increased polymer chain mobility at the surface of the polymer elements due to the effect of treating agents. This enables an increasing reorientation of the polymer chains to a thermodynamically more favorable state with a reduced surface and/or lower roughness of the surface.

In some embodiments, a treating agent comprises at least one active treating agent. During the treatment of the polymer elements, this penetrates the surface of the polymer elements for a period of time, for example at least two seconds to two minutes, to a certain depth, for example 0.5 mm, preferably up to 1 mm and particularly preferably up to 1.5 mm or even further, in quantities and/or concentrations relevant for the change in surface properties and thereby causes (at least partially) a temperature gradient decreasing towards the center of the polymer elements, which is accompanied, for example, by a temperature range of more than 1° C. and particularly preferably of more than 3° C., such as for example more than 7° C., and in this way the most homogeneous and/or isotropic transitions of polymer chain displacements and/or polymer chain reorientations may form. This may have the advantage that no, or no significant, polymer (boundary) layer formations occur in a disadvantageous manner, such as for example gel-like layers and/or other (undesired) layer formations.

Shifting and/or displacing of non-polymer materials such as for example soot or carbon black within the surfaces of elements achieved, for example, by a multi-jet fusion (MJF) process, with the possible effect of a gray or white dyeing on the surfaces by the treatment according to the present invention with at least one treating agent, may be described by special physical processes of the non-polymeric materials within the elements. Elements which are achieved from a white powder by selective laser sintering (SLS) and at least mostly comprise or contain no non-polymer materials such as soot or carbon black remain unaffected by the following description. The basis lies in the theory of a spatial separation of composite materials in additively manufactured elements (e.g. MJF or HSS), which is preferably due to the presence and the effect of different polarities of the materials within a chamber under certain conditions such as temperature and/or pressure. Such elements are preferably made up of at least two components, the polymer and the material, and may have different properties, such as e.g. with regard to their colorability. In this, these fused components are preferably evenly distributed in the elements due to the additive manufacturing method. As a result, the surface of the elements partially consists of material which is not colorable and/or not sufficiently colorable (e.g. soot, glass, polymers without reactive groups such as PTFE). A treatment according to the present invention of such elements may bring about or promote the formation of concentration gradients on the surfaces of elements comprising at least one polymer and at least one material, wherein the concentration of the polymer preferably increases towards the surface.

Preferably, the outer areas of the surfaces of treated elements do not comprise any material or at least mostly no material anymore due to the concentration gradient. For example, gray surfaces of elements may be transformed into white surfaces and dyed without restriction, both simultaneously and with temporal and/or spatial separation.

In several embodiments of the method according to the present invention, the treating agent is heated or heated at a predeterminable heating rate to a temperature that lies between the lower threshold temperature and the upper threshold temperature. Heating rate means the increase in temperature in degrees Celsius per unit of time.

In some embodiments, the characteristic curve of the heating rate when heating the treating liquid and/or the elements is not linear. As the temperature of the treating liquid increases, the heating rate may decrease or be reduced. This effect is explained by the temperature difference of a heating liquid, which is provided by a temperature control unit, for example, and is guided to the chamber wall or to the treating liquid preferably in a separate fluid circuit. At the start of the heating phase, the temperature in the chamber and of the treating agent may be, for example, 20° C. The heating liquid from the temperature control unit may have a temperature, for example, of 220°. This results in a temperature difference of 200° C. between the heating liquid and the chamber wall or treating agent. If the chamber wall and/or the treating agent has, for example, a temperature of 120° C. during the heating phase, the temperature difference to the heating liquid, which still has a temperature of 220° C., is only 100° C. Since at this moment only about half of the temperature difference as at the start of the treatment is present, the heating rate at this point of time or within a time period around this point of time may only be about half of what it was at the start of the treatment. In other words, the speed of heating of the treating liquid in this range or this time period is only about half of what it was at the start of the treatment, whereby the value of the heating rate is also only about the half. In this way, it is realized that in several cases the heating rate at the end of the heating phase, for example, in a range between the upper and the lower threshold temperature, may be only about one third of the initial heating rate.

Since in some embodiments the phase which is particularly decisive for a treatment according to the present invention of elements is between the lower and the upper threshold temperature and/or in certain embodiments of the present invention in a range between a temperature X and an upper temperature turning point (UTCP) of the treating liquid, wherein the temperature X is for example 15° C., preferably 10° C., particularly preferably 5° C., such as for example 3° C. below the upper temperature change point (UTCP), the heating rate should preferably be considered and precisely controlled for such temperature ranges. Thus, in certain embodiments, the heating rate should preferably be considered and controlled between the lower and the upper threshold temperature, and in other embodiments between a temperature X and a temperature on the surfaces of the elements with the highest achievable value within a process (preferably at least approximately identical in value to the upper temperature change point), before a destruction of the surface and/or of the elements occurs. The temperature X is then, for example, 15° C., preferably 10° C., particularly preferably 5° C., such as 3° C. below this measured maximum value of the surface temperature of elements.

According to the present invention, a maximum value of the actual surface temperature (and thus at least very approximately also transferable for the treating agent) may also be referred to as the (upper) temperature change point (UTCP).

In certain embodiments of the present invention, it may be very advantageous to carry out this upper temperature change point (UTCP) within a realistically measurable accuracy (preferably accurate to 0.1° C.) only for a point in time or for as short a period as possible, preferably for less than 60 seconds, particularly preferably for less than 30 seconds, such as for example for less than 15 seconds.

A heating rate and/or the control or the control in a closed-loop manner of a heating rate between the lower threshold temperature and the upper threshold temperature are referred to herein as HRlu. A heating rate and/or the control or control in a closed-loop manner of a heating rate between a described temperature X and a maximum value of the temperature at the surfaces of the elements are referred to herein as HRx. Unless otherwise stated or inferred from the context of the description, the heating rates HRx for a temperature X with a value of 5° C. below the treatment-related maximum value of a surface temperature, i.e. the upper temperature change point (UTCP), may be understood (temperature X=UTCP−5° C.). It has proven to be particularly advantageous that when treating elements with mixtures of alcohols and water, preferably from treating agents containing monohydric alcohols such as ethanol and water, besides the heating rates HRlu the heating rates HRx should be additionally and/or alternatively considered and included in the process management and/or in the process control for certain mixing ratios. In particular for treating agents with mixtures of at least one alcohol such as e.g. ethanol and water at mixing ratios between 55% by weight alcohol and 45% by weight water to 99% by weight alcohol and 1% by weight water, preferably between 75% by weight alcohol and 25% by weight water to 97% by weight alcohol and 3% by weight water and/or when using supplementary forms of energy such as ultrasound or circulation, especially at high flow velocities (also within the chamber) above 0.5 meters/second, it may be advantageous or very advantageous with regard to controlling to heat with the heating rate HRx and regulate it via a control system.

In several embodiments, the heating rate and/or the cooling rate at which the treating agent and/or the elements, for example, within the process chamber, are heated, preferably heated to the maximum temperature thereof, or cooled are predetermined. This heating rate may correspond to the result of the maximum heating capacity of the apparatus; alternatively, it may correspond to a predetermined heating rate course. It has been found that the heating rate, as well as the cooling rate, must not always be kept constant for best results, but must follow a course which the skilled person may determine by a few tests using the specific combination of at least material, treating agent, temperature and/or pressure. Hereby, the flow velocity of the treating agent, for example by circulating a pump and/or supplying additional forms of energy such as ultrasound, should also be taken into account.

In some embodiments, when determining at least one of the threshold temperatures mentioned herein, a movement of the treating agent and/or the granular media is additionally included.

In this, or therewith, when considering the lower and/or the upper threshold, instead of a static consideration, the treatment of the elements may be directed to a dynamic lower and/or a dynamic upper threshold temperature. This can be 1° C. to 20° C., preferably 1° C. to 10° C. below the corresponding static threshold temperatures (considered above).

These dynamic threshold temperatures are determined in the same way as the (static) threshold temperatures described herein, but in addition the treating agent (optionally also the granular media) is set into a flow. The flow velocity is, for example, between 0.1 m/s and 20 m/s, such as between 1 m/s and 5 m/s, and preferably at least approximately as it is also set in the further treatments, for example specified by the pump size and/or the nozzles used.

Without being bound to a theory, it is assumed that a relative movement of treating agent and elements may lead to a faster and stronger heating of the elements by the heated treating agent and/or a relative movement of treating agents and elements (and possibly granular media) enforces a reorientation of polymer chains in a physical manner and/or the penetration behavior, for example, of alcohol and water into the element surface and thus their concentration is executed differently than it is the case with a stationary or almost stationary treating agent.

Without being bound to a theory, it is assumed that in the case of treating agents with high to very high proportions of alcohol, such as between 70% by mass ethanol and 30% by mass water, such as for example 80% by mass ethanol and 20% by mass water, the upper threshold temperature and the lower threshold temperature move constantly closer together and fill an increasingly smaller temperature range, such as for example only up to 2° C. or up to 1° C., or in the case of a treating agent consisting of almost pure alcohol, such as for example 97% by mass ethanol (and 3% by mass water), these two threshold temperatures may at least almost overlap. Particularly in these states, it may be very advantageous to use a temperature control for the observation between the upper temperature change point (UTCP) and a temperature X, wherein the temperature X is preferably 5° C. or 3° C. below the temperature change point (UTCP).

In several embodiments, for example for PA12, the upper temperature change point (UTCP) is in a range between 130° C. and 160° C., preferably between 135° C. and 150° C., particularly preferably between 137° C. and 145° C., such as for example between 138° C. and 144° C.

In some embodiments, for example for TPU such as TPU01 (BASF), the upper temperature change point (UTCP) is in a range between 100° C. and 140° C., preferably between 105° C. and 130° C., particularly preferably between 106° C. and 120° C., such as for example between 107° C. and 115° C.

In some embodiments, starting from an upper threshold temperature, the treating agent is cooled at a predeterminable and controllable cooling rate, preferably to at least one temperature that is below the lower threshold temperature, preferably to a temperature below 70° C., particularly preferably to a temperature approximating the environment temperature, such as for example below 40° C. The cooling rate is to be understood as the reduction of temperature in degrees Celsius per unit of time. In several embodiments, the characteristic curve of the cooling rate during cooling of the treating liquid and/or the elements is not linear. As the temperature of the treating liquid decreases, the cooling rate may also decrease. This effect is explained by the temperature difference of a cooling liquid, which is provided, for example, by a cooling unit such as a flowthrough cooler preferably in a separate fluid circuit, and the chamber wall or the treating liquid. Cooling may start at the (upper) temperature change point (UTCP). At the start of the cooling phase, the temperature in the chamber and of the treating agent may be for example 145° C. The cooling liquid from the cooling unit may have a temperature of, for example, 15° C. Hence, this results in a temperature difference of 130° C. between the cooling liquid and the chamber wall or the treating agent. If the chamber wall and/or the treating agent has a temperature of for example 80° C. during the cooling phase, the temperature difference to the cooling liquid, which may still be for example 15° C., is only 65° C. Since at this moment only about half of the temperature difference as at the start of cooling is still present, the cooling rate at this point of time or within a time period around this point of time, respectively, may only be about half of what it was at the start of the cooling. In this way, it is realized that in several embodiments the cooling rate may be high to very high, especially at the start of the cooling, depending on the system. Thus, after the heating is stopped (i.e. at the upper temperature change point (UTCP)), the point in time or period of time for the upper temperature change point (UTCP) may in preferred embodiments (for a maximum measuring span of 0.1° C.) be kept very short such as for example for 1 to 15 seconds (measured with an accuracy or a measurement tolerance of 0.1° C.) by supplying preferably larger quantities of cooling water which is preferably not in fluid communication with the treating agent and which may be have a low temperature such as between 10° C. and 50° C. and/or by using other cooling methods known to the skilled person. The cooling range between the upper and the lower threshold temperature may preferably also be executed short based on the embodiments described, preferably for less than 10 minutes, particularly preferably for less than 5 minutes, most preferably for less than 3 minutes, such as, for example, for less than 2 minutes. If another, in several embodiments preferred, evaluation of the cooling rate between the upper temperature change point (UTCP) and a temperature X is used for the process management and/or for the control of the apparatus, wherein X is 15° C., preferably 10° C., particularly preferably 5° C., such as for example 3° C. below the upper temperature change point (UTCP), in certain cases, such as for example when using treating agents with mixtures of alcohol and water with ratios above 70% by mass alcohol, (then) this may lead to a more stable and more precise temperature control and thus to a better and higher-quality treatment of the surface properties of elements.

A cooling rate and/or the control or closed-loop control of a cooling rate between the upper threshold temperature and the lower threshold temperature is herein denoted as CRul. A cooling rate and/or the control or closed-loop control of a cooling rate between a described temperature X and a maximum value of the temperature at the surfaces of the elements is indicated herein as CRx. It has proven to be particularly advantageous that when treating elements with mixtures of alcohols and water, preferably with treating agents containing monohydric alcohols such as ethanol and water, the cooling rates CRx should be considered additionally and/or alternatively for certain mixing ratios in addition to the cooling rates CRul and included in the process management and/or in the process control. In particular for treating agents with mixtures of at least one alcohol such as ethanol and water at mixing ratios between 55% by mass alcohol and 45% by mass water to 99% by mass alcohol and 1% water, preferably between 75% by mass alcohol and 25% by mass water to 97% by mass alcohol and 3% water, it may be advantageous or very advantageous with regard to controlling to cool and control in a closed-loop manner with the cooling rate CRx. In particular when using supplementary energy sources such as for example electromagnetic induction, pulsation, circulation, pump flow, sound and/or ultrasound simultaneously, it is particularly advantageous to evaluate and control the cooling and the cooling rates according to the CRx consideration.

In certain embodiments, the upper temperature change point (UTCP) may optionally be considered as a very short change range (time period) instead of a point, wherein such periods range within a few seconds. In this way, for example, the temperature measurement tolerance of preferably approximately 0.1° C. accuracy may be taken into account or at least be roughly corrected, respectively.

In certain embodiments, the at least one fluid communication for a warming liquid or heating liquid and the at least one fluid communication for a cooling liquid may be the same part or section of the apparatus, preferably the same hose line and/or pipe line, at least in the section of the chamber and/or the chamber wall.

In several embodiments, supplementary forms of energy such as circulation, swirling, pump flow, fluid flow, pulsation, sound, ultrasound, magnetism, induction, vibration or other methods known to the skilled person of an additional, i.e. supplementary introduction of energy such as, e.g., kinetic energy may be carried out before the heating phase and/or during the heating phase and/or during the cooling phase and/or after the cooling phase, and indeed continuously and/or intermittently. The capacity and/or intensity and/or effect on the elements may for the at least one supplementary form of energy also be changed, increased or reduced during the aforementioned periods or intervals.

If, in the method according to the present invention, supplementary energy sources are used in addition to direct warming up or heating of treating agent and/or elements by heating devices, it may be advantageous to determine the lower threshold temperature as described herein and, in addition, to include therewith at least one of said supplementary energy sources with at least a comparable effect in the tests and/or the determination of values. In this, the lower threshold temperature may display a few degrees Celsius lower than it would be the case without such supplementary or additional energy sources, for example 1° C. to 15° C. lower.

The determination of the upper threshold temperature with the presence and/or participation of supplementary energy sources may be carried out by a skilled person by proceeding as described above for the determination of the upper threshold temperature and, in addition, optionally including the at least one supplementary or additional energy source in the experimental determination of the upper threshold temperature at least to the greatest possible extent with regard to its or their effect. In this, the upper threshold temperature may display lower by several degrees Celsius than it would be the case without such supplementary or additional energy sources, such as 1° C. to 20° C. lower.

In some embodiments, the period, during which elements are in a treating agent between the lower and the upper threshold temperature during the heating phase, is between 60 seconds and 30 minutes, preferably between 90 seconds and 15 minutes and particularly preferably between 2 minutes and 8 minutes.

In some embodiments, the period, during which elements are in a treating agent between the upper and the lower threshold temperature during the cooling phase, is between 10 seconds and 15 minutes, preferably between 20 seconds and 10 minutes and particularly preferably between 30 seconds and 5 minutes.

In several embodiments, the time, during which elements are in a treating agent between a temperature X (temperature X=UTCP−5° C.) and the upper temperature change point (UTCP) during the heating phase, is between 20 seconds and 20 minutes, preferably between 40 seconds and 10 minutes, and particularly preferably between 60 seconds and 5 minutes.

In some embodiments, the time, during which elements are in a treating agent between the upper temperature change point (UTCP) and a temperature X (temperature X=UTCP−5° C.) during the cooling phase, is between 10 seconds and 10 minutes, preferably between 20 seconds and 8 minutes and particularly preferably between 25 seconds and 5 minutes.

In some embodiments, the time, during which elements are in a treating agent between a temperature X (temperature X=UTCP−3° C.) and the upper temperature change point (UTCP) during the heating phase, is between 13 seconds and 13 minutes, preferably between 25 seconds and 7 minutes, and particularly preferably between 40 seconds and 4 minutes.

In some embodiments, the time, during which elements are in a treating agent between the upper temperature change point (UTCP) and a temperature X (temperature X=UTCP−3° C.) during the cooling phase, is between 10 seconds and 15 minutes, preferably between 15 seconds and 8 minutes and particularly preferably between 20 seconds and 3 minutes.

In several embodiments, the heating rate may be greater overall than the cooling rate, at least with respect to the same temperature range, in other embodiments it is the other way around. In particular embodiments, the heating rate and the cooling rate are equal or nearly equal, preferably at least in a certain temperature range.

In several embodiments, the heating rate and the cooling rate may be considered in their total periods in percentage ratios to each other, such as for example between 20% to 80% and 80% to 20%, preferably between 30% to 70% and 70% to 30%, particularly preferably between 60% to 40% and 40% to 60%.

In some embodiments, the ratio between the heating rate HRlu and the cooling rate CRul is in percentages ranging from 90% to 10% to 20% to 80%, preferably from 80% to 20% to 30% to 70%, and particularly preferably from 70% to 30% to 40% to 60%. The method may be controlled or controlled in a closed-loop manner according to the aforementioned or following ratios.

In several embodiments, the ratio between the heating rate HRx and the cooling rate CRx with X=3° C. is percentages from 40% to 60% to 2% to 98%, preferably from 30% to 70% to 3% to 97% and particularly preferably from 20% to 80% and 5% to 95%.

In several embodiments, the ratio between the heating rate HRx and the cooling rate CRx with X=5° C. is percentages from 40% to 60% to 8% to 92%, preferably from 30% to 70% to 10% to 90% and particularly preferably from 25% to 75% and 12% to 8%.

In certain embodiments, alcohols can contain a denaturant. For example, ethanol may be denatured with about 1-3% methyl ethyl ketone (MEK). According to the present invention, such a denaturant is considered as a mass fraction within the alcohol. In other words, a mixture of for example 95% by mass ethanol and 5% by mass water (for example demineralized water) may contain 2% by mass methyl ethyl ketone (MEK) within the ethanol, and yet the concentration according to the present invention is 95% by mass ethanol and 5% by mass water.

In some embodiments, the control system used in the apparatus according to the present invention is (particularly preferably) programmed or configured such that it may react to the temperature management of the processes and methods with an accuracy of up to approximately 0.1° C., both during the heating(-up) phase, in the area of the upper temperature change point (UTCP) and also during the cooling phase. A high accuracy of the temperature control of approximately 0.1° C. is particularly promoted by the interaction of the control system used with a high thermal mass of the treating liquid (preferably over 20 liters) and the comparatively low thermal mass of the elements. Overdriving the temperature, for example, by a PID controller during heating, which measures the internal temperature of the treating agent at least at one site, preferably by a Pt1000 or Pt100 sensor, is greatly minimized in this way. If, in certain embodiments of the present invention (usually during the test phase for new treating agents and elements), the temperature in the area of the upper temperature change point (UTCP) is nevertheless (slightly) overdriven, i.e. the actual temperature of the treating agent is a certain value, for example 1° C., above the target temperature, this may be corrected by the skilled person in the software, for example, by reducing the target temperature by 1° C.

A possible overdrive or overregulation of the actual target temperature may occur, for example, if physical effects and/or shifts occur within the chamber due to the interaction of preferably at least two treating agents and the gas phase formed above them, which may lead to short-term capacity shifts.

In several embodiments, the apparatus according to the present invention may be designed stationary and/or fixed, in other embodiments the apparatus may be moved, such as displaced, rotated and/or tilted.

In some embodiments, the apparatus may be equipped with temperature control units for heating treating agents, such as those used for the temperature control of injection molding tools. Such temperature control units may have heat capacity, for example between 1 kW and 50 kW, particularly preferably between 4 kW and 25 kW, particularly preferably between 5 kW and 15 kW, such as between 6 kW and 12 kW.

In several embodiments, the chamber comprises a cover having a thickness of between 20 mm and 80 mm, preferably between 40 mm and 60 mm and particularly preferably between 45 mm and 55 mm, such as between 48 mm and 53 mm.

In some embodiments, the method according to the present invention comprises measuring the surface roughness of elements and/or reference components prior to treatment, i.e. prior to a step a), by devices or methods as known to the skilled person, such as by measuring and recording Ra values. Such initial values, preferably of several measured values of the surface roughness of elements, may be entered or read into the control. In a subsequent step, the desired (preferably average) surface roughness of elements may be entered into the control system in accordance with the treatment according to the present invention or selected from a preset of possible values of achievable (lower, average and/or upper) surface roughnesses. Based on this and possibly other data, such as the name and concentration of the treating agent used, the control may calculate the required parameters for the treatment, such as temperature thresholds, temperature maintaining periods and heating and cooling rates, and execute these as required. In an optional embodiment, the control system may also include the geometric data of the elements to be treated, preferably in the form of their CAD data (STL, STEP or other) for calculating the parameters for surface treatment. In addition, further data or information such as the material and the individual additive manufacturing method may be included for the calculation of the parameters. Possible parameters for the treatment and/or smoothing and/or functionalization of elements may be, for example: Mixing ratio of treating agent, pressure, temperature, time, heating rates, cooling rates, lower threshold value, upper threshold value, (upper) temperature change point (UTCP), shape and size of elements, material and manufacturing method of elements, type and size of granular media, material and amount of granular media, type and size of smoothing, treating or functionalization agents, material and quantity of smoothing agents, treating agents or functionalization agents, the intensity of the circulation and the effect of supplementary forms of energy such as pulsation, sound, ultrasound, flow velocity and flow direction, for example, by nozzle control.

Preferably, at least one pump is used to accelerate and/or circulate the treating agent and/or the elements and/or at least one functionalizing agent and/or granular media, wherein this pump may be designed for pressures of at least 10 bar, preferably at least 15 bar and particularly preferably at least 20 bar.

The pump may be used as a circulation pump which conveys treating agents, functionalizing agents and/or granular media out of the process chamber and back into it. The pump preferably serves no other purpose and/or is not additionally in fluid communication for any purpose.

For this purpose, the pump may be arranged inside the process chamber or outside the process chamber

The pump may be part of the apparatus according to the present invention.

In some embodiments, the pump is arranged to convey treating agent out of a container, into the process chamber and from there back into the container, and is thus used. Such an additional container may be provided with an additional heating device and/or cooling device. It may be part of the apparatus according to the present invention.

In several embodiments, at least one of the polymer elements is made of or comprises at least one polyketone (PK) and is treated with a treating agent in a liquid state, in particular smoothed. In this, the treating agent contains at least one benzyl alcohol, a propylene carbonate, a citric acid triethyl ester and/or an N-cyclohexyl-2-pyrrolidone (CHP). The treatment temperature is preferably at least 130° C.

In some embodiments, at least one of the polymer elements is made of or has a polypropylene (PP) and is treated, in particular smoothed, with a treating agent in a liquid state. In this, the treating agent contains at least one 3-methoxy-3-methyl-1-butanol acetate or a D-limonene. The treatment temperature is preferably at least 80° C.

In several embodiments, at least one of the polymer elements is made of or has at least one ESTANE® 3D TPU thermoplastic polyurethane and is treated, in particular smoothed, with a treating agent in a liquid state. The treating agent contains at least one n-butylpyrrolidone, a benzyl alcohol, a 3-methoxy-3-methyl-1-butanol or a citric acid triethyl ester. The treatment temperature is preferably at least 80° C.

Some or all embodiments according to the present invention may have one, several or all of the advantages mentioned above and/or below.

A further advantage of the present invention may be that the elements achieved by additive manufacturing methods may be treated as bulk material. Using the present invention, it may advantageously be avoided that the surfaces of the elements become sticky due to the treatment and/or that several elements stick permanently to each other.

Furthermore, a further advantage of the present invention may be that a method for treating bulk material using environmentally friendly materials is provided and the use of large quantities of environmentally harmful organic solvents is avoided. This contributes significantly to environmental protection.

Using the present invention, it may further advantageously be possible to provide a method that may be used for both delicate parts and bulky parts.

A further advantage of the present invention may be that the reactivity may be precisely and easily adjusted. This also makes it possible to treat sensitive parts with a treating agent, since the treatment time may be precisely determined and applied when using the method according to the present invention.

Using the method according to the present invention, both single polymer elements and bulk material, i.e. several polymer elements simultaneously in the same process, may advantageously be treated by one method, wherein the method may be used for smoothing and possibly also for functionalizing manufactured elements which have been produced from different polymer types and in particular from polymers and copolymers based on polyamide as well as based on TPU.

A further advantage of the present invention may be that it is possible to provide elements achieved by a generative manufacturing method with a smooth, matt and/or textured surface by treating the elements with the method according to the present invention, wherein the method enables to smooth surfaces of elements with very filigree parts, with high complexity, with channels, holes and fine structures in a short time and at comfortable temperatures.

Furthermore, by the present invention, it is advantageously possible to treat the surface(s) of these elements in order to provide them with desirable functions, to dye them or to functionalize them.

Advantageously, by using a liquid mixture of water (preferably demineralized water) and alcohol in predetermined proportions at a predetermined temperature and for a predetermined period, the present invention enables efficient smoothing of the surface of elements and simultaneous treatment of multiple elements as well as bulk material, as the elements are suspended in the treatment liquid and do not stick to each other. The start and stop of the smoothing reaction may advantageously be controlled by controlling the temperature regime and the treatment period. It is thus possible to control the entire process advantageously precisely so that a softening of surfaces, deterioration of surfaces, rounding and a softening of contour lines etc. may be avoided.

With glycols such as, for example, propylene glycol or simple alcohols such as ethanol or isopropanol or aqueous or non-aqueous mixtures thereof, for smoothing by dipping or by bulk material smoothing, respectively, other properties may advantageously be achieved in addition to high smoothing or low surface roughness. For example, with MJF elements or HSS elements or with black SLS elements, a coloring or dyeing of surface from white to black or shades of gray in between, respectively, may be achieved. Due to the additive manufacturing process, such elements are black inside and often comprise an uneven gray surface, because in MJF processes and HSS processes, white residual powder of the actually white powder sticks to the element surface, at least in small quantities. The described coloring from white to black may be achieved by both the smoothing process itself, for example by selecting the corresponding treating agent and/or corresponding treatment periods and/or treatment temperatures, as well as a corresponding pre- and/or post-treatment. For example, the polarity of the granular media may lead to greater mixing on the surface of the polymer elements, so that they become more black. This is preferably the case with granular media with non-polar properties. Granular media with strongly polar pronounced properties may strengthen the effect of gray dyeing or white dyeing, depending on the materials used for the elements. Likewise, the type and method of post-treatment in relation to the media used (air/gas/vacuum/liquid) and the temperatures used may affect the coloration of such surfaces. Thus, it was found that post-treatment temperatures of 20° C. to 80° C. may constantly effect a preferably lighter coloration on the surface of the elements than post-treatment temperatures of over 80° C. Without being bound to a theory, it is assumed that at lower post-treatment temperatures up to 80° C., the residual treating agent remaining in the surface or at least parts of it escape slowly or relatively slowly and thus no further displacement or mixing of polymer and carbon black or soot is ensured. At temperatures above 80° C., preferably above 100° C., the escape of at least parts of residual treating agent in the surface of the elements may be increasingly intensified and a further or renewed displacement of carbon black on the polymer surface may occur. In other words, it is assumed that at a post-treatment temperature over 80° C. at least constituents of the carbon black or soot being pressed at least partially towards the inside on the direct element surface due to the smoothing step preferably are pressed towards the outside or are entrained again together with the now more fiercely escaping residual treating agent or parts of it as it is the case with lower temperatures, thus ensuring an increased mixing of carbon black or soot and polymer material in the outside layer.

A further advantage of the present treatment may be the possibility of carrying out mechanical surface treatments before, during or between post-treatments. These may cause microstructures on the cured surface of the polymer elements, which are permanently visible on the surface after preferably at least one further post-treatment. Such microstructures thus advantageously effect, for example, grained or matt surfaces. Simultaneously and/or alternatively, the surface roughness may advantageously be further reduced or modified by at least one mechanical post-treatment before, during or between the post-treatments.

In addition, a further advantage of the present invention may be that by using the method according to the present invention it is possible to change the color of the surface of elements containing carbon black or similar substances such as soot, graphite or carbon fibers, which enables coloring elements in many color shades during the process or in a further process step and/or bringing about a change in the surface properties of the elements by a local displacement or rearrangement of such substances, preferably to a depth of 0.2 mm, particularly preferably to a depth of 0.5 mm.

If at least two treating agents are used, at least one of which is used as an inactive treating agent or inactive substance according to the present invention, this may have the advantage that the treated elements do not have to be subject to a further process in a furnace with high or very high temperatures after treatment in order to get relevant residual amounts of treating agent or solvent out of the surface again as quickly as possible, for example at temperatures above the glass transition temperature or the recrystallization temperature of the polymer used for the elements and/or at temperatures above 100° C. or even above 150° C. This may help to save time and costs and/or to prevent the elements from damage.

A further advantage of the method according to the present invention may be that, since it can be gentle on the polymer elements, it leads to improvements on and within their surfaces up to depths of 1.5 mm and sometimes beyond. These improvements may be, for example, a strengthening of the mechanical properties, a reduction in the wear properties, a reduction in the friction coefficient, a reduction in the oxidation behavior, an increase in the chemical resistance and/or a reduction in the surface roughness.

The method may advantageously encompass further effects such as deep cleaning, infiltration, functionalization, removal of residual powder, surface smoothing and/or sterilization of the surfaces of the polymer elements.

A further advantage of the method according to the present invention may be that it leads to increased polymer chain mobility on the surface of the polymer elements due to the effect of the treating agent. This enables an increasing reorientation of the polymer chains to a thermodynamically more favorable state with a reduced surface and/or lower roughness of the surface.

All the advantages that may be achieved with the method according to the present invention may also be achieved undiminished with the apparatus according to the present invention in certain embodiments according to the present invention and vice versa.

All embodiments described with respect to an apparatus according to FIG. 1 may be combined with an additional dyeing step and/or functionalization step by introducing suitable substances into the process chamber either before and/or during the smoothing step b) (see FIG. 4) and/or thereafter, for example, in a time window after smoothing as described above.

### BRIEF DESCRIPTION OF THE DRAWINGS

In the following, the present invention is described purely exemplarily with reference to the accompanying figures. In them, identical reference numerals denote identical or similar components. The following applies:

FIG. 1 shows an apparatus according to the present invention for carrying out the method of the present invention;

FIG. 2 shows the process chamber of the apparatus for carrying out the method in a second embodiment;

FIG. 3 shows the process chamber of the apparatus for carrying out the method in a third embodiment with a second process chamber; and

FIG. 4 shows schematically simplified the course of a method according to the present invention in an embodiment.

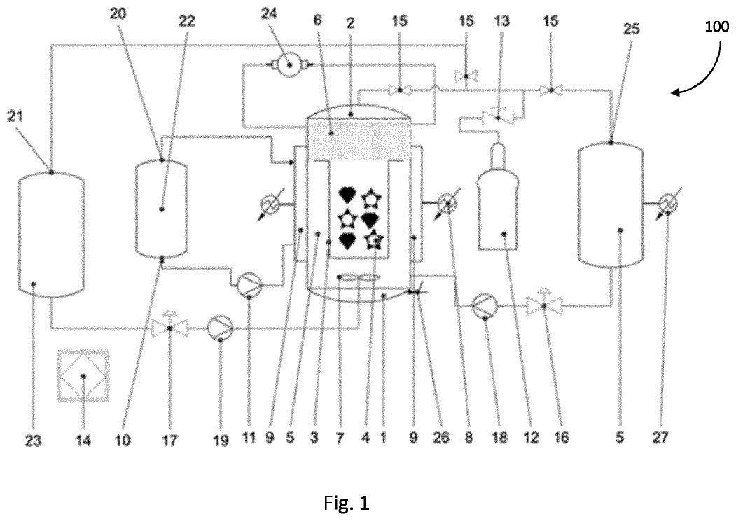

FIG. 1 shows an apparatus 100 according to the present invention for carrying out the method of the present invention.

### DETAILED DESCRIPTION OF THE INVENTION

This exemplary embodiment exemplarily explains the apparatus according to the present invention in one embodiment without restricting the scope thereto.

The polymer elements may for example be treated in an apparatus as claimed in the present application and as shown in FIG. 1. The apparatus comprises a chamber or process chamber 1 with an optional cover 2, and comprising at least one inner container 3 for receiving the polymer elements 4 and the treating liquid 5.

Devices for temperature control 26 are further provided, wherein the apparatus preferably further comprises at least one of the following devices: a circulation device 7, a heating device 8 and/or at least one coolant tank 10, 20. In this, the coolant tank 10, 20 comprises a cooling fluid or coolant 22. This device is described and explained in more detail below and in the example.

The process chamber 1 is optionally designed as a pressure vessel and may comprise a cover 2, which is provided and/or suitable for closing the process chamber 1 in a pressure-tight manner.

The polymer elements 4 may be introduced into the process chamber 1 by the inner container 3 either as bulk material or in special chambers and/or holding devices (not shown) on and inside the inner container 3.

The treating liquid 5 may be introduced into the process chamber 1 in various ways.

The circulation device 7, preferably an impeller, is capable of continuously stirring the treating liquid 5.

Chambers and/or installations may be useful if the polymer elements 4 tend to stick together during smoothing, as may be the provision of granular media within the process chamber 1.

This depends, among other things, on the geometry of the polymer elements and the polymer used as well as on the smoothing intensity to be applied.

By constant stirring, the circulation device 7 prevents the polymer elements 4 from sticking to each other or to the walls of the process chamber 1.

As described above, the treating liquid 5 may be introduced in different ways.

In a first variant thereof, the polymer elements 4 are introduced into the process chamber 1 and the cover 2 is closed in a pressure-tight manner.

The treating liquid 5 is then introduced into the process chamber 1 out of the reservoir 25 by a pump 18 and/or by pressurization by process gas out of a tank 12 according to a predetermined level. In some embodiments, the treating liquid 5 may already have been brought to a predetermined temperature in the reservoir 25 for treating liquid 5 by a heating device 27.

The process chamber 1 may already be filled with process gas from the tank 12 under a certain pressure in advance in order to generate a counterpressure during the introduction phase of the treating liquid 5 and/or to strongly prevent sudden evaporation of the treating liquid 5. A pressure relief valve 13 may be provided in fluid communication with the tank 12 containing process gas.

The conditions should be such that the treating liquid 5 is in liquid state.

In a special embodiment, a vacuum pump 24 ensures the displacement of almost any oxygen in the process chamber 1 before any gases or liquids are introduced into the process chamber 1.

An ideal (filling) level for the treating liquid 5 depends on various factors, which shall be described in more detail below.

It is optionally provided not to fill the entire process chamber 1 with treating liquid 5 so that vapor 6, from whatever source or liquid, in particular treating liquid 5, can fill the remaining space in the upper part of the process chamber 1.

In several embodiments, it is provided to first hold the polymer elements 4 in the vapor 6 in the upper part of the process chamber 1 for a predetermined period before allowing them to be immersed in the treating liquid 5.

If necessary, the treating liquid 5 may be heated to a temperature of approximately the lower threshold temperature of the polymer elements 4, wherein the lower threshold temperature not only depends on the concentration and composition of the treating liquid 5, but may also depend on the polymer used for the elements 4 and also on the manufacturing process.

If there is a sufficient amount of treating liquid 5 in the process chamber 1, the valve 16 may be closed. Embodiments in which the treating liquid 5 is not introduced into the process chamber 1 from the outside, e.g. controlled via a valve, are also disclosed herein.

Subsequently, preferably process gas 6 is introduced into the process chamber 1.

The circulation device 7 may be switched on before, at the same time or afterwards in order to distribute or circulate the treating liquid 5 and the polymer elements 4.

The treating liquid 5 and the polymer elements 4 are brought to the required smoothing temperature by a heating device 8.

This is preferably done with a comparatively high to very high heating rate.

In order to control the temperature of the treating liquid 5 as exactly as possible, preferably within the process chamber 1, a control device or closed-loop control device 14 is optionally provided.

Moreover, the control device or closed-loop control device 14 may be programmed to execute or initiate, the method according to the invention in any embodiment disclosed herein, for instance by control commands to the components and/or actuators required for this purpose, in particular as disclosed herein.

Preferably, the temperature is continuously monitored by temperature sensors 26. Devices may be provided to heat as exactly as possible to the predetermined smoothing temperature with a predetermined heating ramp.

A very fast heating rate is just as desirable as maintaining the temperature within a predetermined temperature range.

Devices (not shown) for a non-linear temperature rise, temperature ramps and/or a certain inert temperature rise or temperature fall by a few degrees (Celsius) after reaching the smoothing temperature may be provided to further improve the method.

After a predetermined smoothing time, i.e. the duration of smoothing step b), the temperature to which the polymer elements 4 are exposed is preferably actively decreased to the lower threshold temperature range or lower, optionally with (or at) a predetermined cooling rate, which is advantageously high to very high.

This is preferably done via a cooling line 9 within the process chamber 1, which may be supplied with a coolant 22, preferably water, by a pump 11.

Additionally or alternatively, other devices for cooling may also be used, such as applying liquid nitrogen or discharging process vapor.

After reaching the lower threshold temperature, the treating liquid 5 may be pumped back into the reservoir 25, if present.

Optionally, the polymer elements 4 may be further treated by a rinsing liquid or a downstream dyeing and/or functionalizing liquid 23, which is provided by a pump 19 from a further container 21 via a valve 17 into the process chamber 1. This functionalization liquid 23 may then, i.e. after the downstream treatment, be pumped back into the container 21 and, in some embodiments, reused.

The functionalization liquid 23 can be simple water at room temperature in order to reduce the residual temperature of the polymer elements 4 and the process chamber 1 to approximately room temperature as quickly as possible in order to be able to remove the treated polymer elements 4 after opening the cover 2.

The process can be repeated.

FIG. 1 also shows gas valves 15 with which the gas supply into the process chamber 1 can be metered or controlled during, and for, the treatment.

In order to save energy, it may be advantageous to heat the polymer elements 4 and the treating liquid 5 separately and to recover the treating liquid 5 during cooling down below the lower threshold temperature.

This may be done using a configuration in which the treating liquid 5 is heated to a temperature in the range of the upper threshold temperature or beyond in a separate container (not shown).

The heated treating liquid 5 may then be pumped into the process chamber 1 comprising the polymer elements 4 and/or comprising the polymer elements 4 and water or an aqueous solution for pre-treatment. If treating liquid 5 with a temperature in the range of the upper threshold temperature or beyond is fed into the process chamber 1, the temperature will be slightly lowered by the lower temperature of the polymer elements 4 and the thermal mass of the process chamber 1. This allows fast heating of the polymer elements 4 to the smoothing temperature and a fast smoothing effect.

### Example

Polymer elements were smoothed using the method of the present invention. The polymer elements were first treated at a temperature below a lower threshold temperature at which the time is not critical.

Only upon exceeding this temperature does a noticeable reaction take place. Below the lower threshold temperature, no smoothing or change in the surface occurs neither in a few minutes nor over a period of several hours. This means that the polymer elements may remain in the treating liquid or another pre-treating liquid such as water or an aqueous solution for any period. This allows high flexibility for the process. The lower threshold temperature depends on the treating liquid and on the type of polymer elements to be treated. Thus, the lower threshold temperature may vary, e.g. depending on the polymer elements produced by different manufacturing processes such as SLS and MJF. It may generally be assumed that this lower threshold temperature is at least 5° C. and up to 50° C. or more below the upper threshold temperature.

The “lower threshold temperature” does not necessarily have to be an exact temperature value, but may be a temperature range comparable to the melting range of a polymer.

As smoothing starts slowly beyond the lower threshold temperature, this is not critical as long as any pre-treatment that should not start with the smoothing is carried out well below the lower threshold temperature. If polyamide elements are treated and the treating liquid is a water-alcohol-mixture with a ratio of water to alcohol of 60:40 to 40:60, the lower threshold temperature is normally higher than 100° C. and lower than 145° C.

Until the lower threshold temperature is reached, the heating rate does not play a significant or direct role in the polymer element quality.

The actual smoothing process starts slowly as soon as the lower threshold temperature is reached. This temperature may be maintained for some time or, alternatively or additionally, one or more temperature holding cycles may be set up to heat the treating liquid and possibly the polymer elements to approximately the lower threshold temperature. These holding cycles, or alternatively a delayed heating rate, may be advantageous to saturate the polymer elements with water using an aqueous medium such as water or a water-alcohol-mixture. In other words, the polymer elements may be pre-treated with water or an aqueous liquid or the treating liquid before the smoothing step as such starts, which means that the polymer elements may be contacted with an aqueous medium at a lower temperature and heated slowly or held at a temperature below the lower threshold temperature for any useful period. Smoothing begins when the treating liquid is heated to a temperature above the lower threshold temperature. Different approaches to heating are possible.

In one approach, the treating liquid with the polymer elements therein is heated very quickly from the lower threshold temperature, preferably at most or preferably at least, to the upper threshold temperature.

The heating rate should preferably be high to very high. The temperature should be controlled as exactly as possible. In addition to the generally known heating characteristics, it is preferred to control and detect possible energetic fluctuations in the process chamber through evaporation and to provide devices to counteract these in a process-improving manner, for example by providing circulating, driving or propellant devices. Once the upper threshold temperature or a temperature close to it has been reached, e.g. 1° C. to 5° C. below the upper threshold temperature, this temperature may be maintained for a short period, e.g. a few seconds up to a few minutes. The temperature regimen may be adapted in order to achieve optimal results, for example by using a predetermined heating rate until a desired temperature of 1° C. to 5° C. below the upper threshold temperature has been reached, wherein this temperature is held for a few seconds or up to 2 minutes and then (this) cools down with a predetermined cooling rate, or without. Heating rate and holding time may be adjusted for optimal results and the optional cooling rate may also be adapted accordingly.

For example, devices may be provided to allow a shorter or longer holding time and adaptation of temperature ranges by fast or slow temperature increase and/or temperature decrease. In general, it is preferred to have a fast increase in temperature to the predetermined smoothing temperature and a fast decrease in temperature to the lower threshold temperature in order to stop smoothing as fast as possible. Time periods for the increase and decrease in the range of less than 5 minutes, preferably less than 2 minutes are preferred.

The smoothing step is followed by a cooling step in which the temperature inside the process chamber is lowered.

This may be done with any devices known in the prior art and may be done as quickly as possible and/or in a controlled manner at least until the lower threshold temperature is reached, preferably by active cooling media. Examples of active cooling devices are pipe cooling lines or cold exchangers arranged inside the process chamber. A further possibility to quickly lower the temperature may be achieved by selectively discharging process gas within the process chamber, preferably into a third chamber. By selectively discharging process vapor into a deliberately arranged gas area above the actual treating liquid within the process chamber, further vapor is generated from the liquid, which leads to cooling of the treating liquid.

Typical heating rates from the lower threshold temperature to the upper threshold temperature are 1° C./min to 60° C./min, such as 5° C./min to 20° C./min.

Cooling rates can be in the same range, but can also be slower or faster.

In an alternative embodiment, the treating liquid, for example an ethanol-water-mixture, is not heated each time from about room temperature to the lower threshold temperature, but is pumped after the smoothing step into a second chamber, where it is maintained at about the same temperature and may be used again for the next smoothing load.

In another approach, the ethanol-water-mixture is heated separately to a temperature higher than the lower threshold temperature, for example to the upper threshold temperature or beyond in a second chamber. In this approach, the temperature of the treating liquid should at most be such that when the treating liquid comes into contact with the polymer elements to be smoothed, the temperature drops during pumping from the second chamber into the process chamber and/or by contact with the polymer elements down to approximately the upper threshold temperature. In the process chamber, this temperature can either be maintained as a function of the initial temperature and the thermal mass of the process chamber wall and the polymer elements or it may be set to the optimum upper threshold temperature by active heating or cooling. After a predetermined treatment time with the preferred smoothing process parameters or within the preferred smoothing process parameter ranges, the temperature of the treating liquid is brought back below the lower threshold temperature by the cooling options already described.

The treating liquid may then be pumped back into a second chamber.

In another approach, the treating liquid 5 from the reservoir 25 is not cooled to or below the lower threshold temperature, but is preferably maintained in a second chamber at a temperature suitable for smoothing, such as slightly above or at the upper threshold temperature.

When the treating liquid 5 at a temperature of approximately the upper threshold temperature or slightly below or above is fed into the process chamber 1, its temperature is slightly lowered by the lower temperature and the thermal mass of the process chamber 1 and the polymer elements 4 arranged within the process chamber 1. This approach allows fast heating of the polymer elements 4 in shorter time than by heating the polymer elements 4 directly in the treating liquid 5. Therefore, this approach is suitable in cases in which fast heating and smoothing is required. Heating the treating liquid 5 and the polymer elements 4 together normally requires more time since the heating device 8 can only bring a certain heating capacity. In an alternative method, the smoothing process may be stopped more slowly so that the surface of the polymer elements is in a transition phase in which the surface is still soft. This is useful if a functionalization step is carried out following the smoothing step or if a second smoothing step follows. This improves finishing of the surface while maintaining the exact geometric contours.

Another way to stop the smoothing process is to introduce liquid nitrogen into the chamber. This may be advantageous if the inlet pressure is kept as low as possible by introducing compressed air and/or process gas

In an additional step of an embodiment of the method according to the invention or as part of one or more of the steps, dyes and/or fillers may be added to the polymer element surface during the method.

To do this, the alcohol-water-mixture is mixed directly with the dye and/or the fillers. Dyeing with dispersion dyes, metal complex dyes or acid dyes or sulfur dyes may also be done either directly after smoothing or in the process chamber with an additional color tank 23. Coloring directly after the smoothing process may have advantages in coloring, because the surface still has a certain softness due to the ethanol content, whereby certain dyes or fillers may better and in a shorter time penetrate the surface under certain circumstances.

In addition to alcohols, substances that increase the polarity of water can also lighten MJF and HSS components on the surface. Without being bound to a theory, it is assumed that an increasing polarity of the liquid increasingly displaces the relatively non-polar carbon black within the components mentioned inwards, and namely preferably at a temperature above the crystallinity range of the polymer. Suitable materials for the whitening are e.g. tap water or mineral water. However, in several embodiments, the temperature should be raised significantly in the range of crystallinity temperature. If salts are to be added to the water, this may already be done at temperatures of approx. 140° C. It has been shown that generally by treating polymer elements with a salt solution, for example an aqueous solution of a salt such as NaCl and/or Na₂CO₃, for example in a concentration of approx. 1% by weight to approx. 20% by weight, the surface of the polymer elements may become light gray to whitish. This is achieved for polymer elements obtained by additive manufacturing when they contain carbon black, independent of a treatment with a water-alcohol-mixture for smoothing as described above. For the brightening or whitening effect, a salt solution may be used together with the above-mentioned additives such as benzyl alcohol, glycerine, glycols or plasticizers, which are used in small quantities.

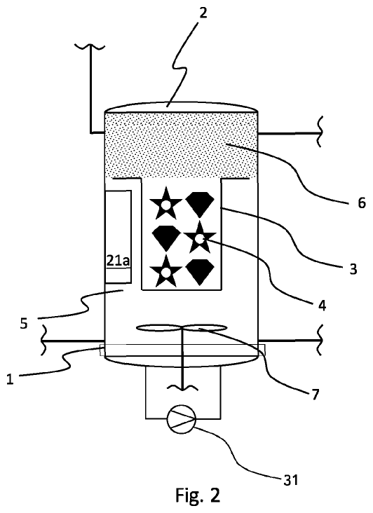

FIG. 2 shows the process chamber 1 of the apparatus 100 for carrying out the method in a second embodiment.

For better clarity, only the process chamber 1 of the apparatus 100 (with sections of its supply and discharge lines) are shown in FIG. 2. Reference is made to the reference numerals and statements of FIG. 1.

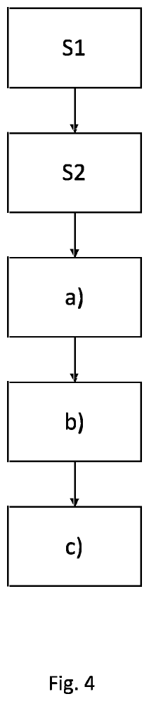

If an additional coloring step and/or functionalization step is to be carried out, either during the smoothing step b) (see FIG. 4) and/or afterwards, this is done by introducing suitable substances into the process chamber 1.

The example of FIG. 2 shows the process chamber 1 with a container 21a for coloring agents or functionalizing agents received therein, from which container 21a the substance may be introduced into the process chamber 1, in particular automatically, at a suitable time by suitable devices provided for this purpose (e.g. pumps, valves or the like).

The container 21a may be filled with, for example, dyes (liquid or as powder), pigments, functionalizing agents (e.g. as powder or with fibers) or with additives.

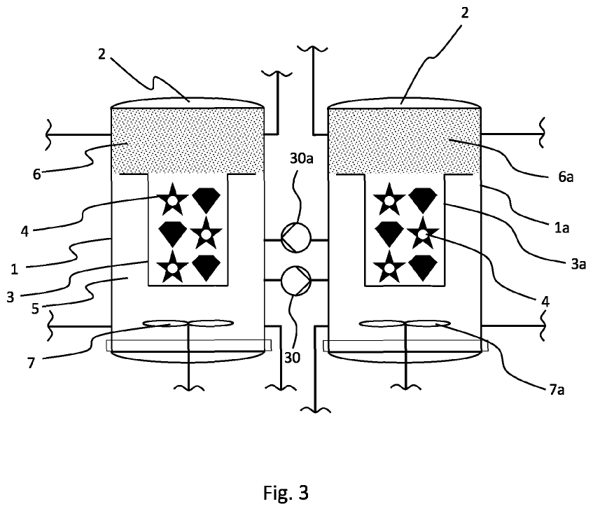

In FIG. 2, unlike FIG. 1 or FIG. 3, a pump 31 is shown which is optional and may be provided in any embodiment, e.g. also in that of FIG. 1 or FIG. 3, wherein more than one such pump 31 may also be provided. Furthermore, the pump 31 is not limited by the specific embodiment of FIG. 2. The following statements relating to the pump 31 are therefore not limited to the pump 31 shown in FIG. 2. Rather, the pump is to be understood as disclosed independently of further features of FIG. 2.

The pump 31 may preferably be used to accelerate and/or circulate the treating agent and/or the elements and/or at least one functionalizing agent and/or granular media. The pump may be designed in form of, for example, a heat transfer pump, a radial impeller pump or a peripheral impeller pump. The pressures prevailing within chamber 1, of for example at least 5 bar, preferably at least 10 bar and particularly preferably at least 15 bar, must be taken into account on the basis of the permissible housing pressure of the pump.

The permissible housing pressure of such a pump must be coordinated with the process pressures prevailing inside chamber 1, for example up to 10 bar or even up to 20 bar.

In several embodiments, the capacity consumption of a pump 31 is at least 1 kW, preferably at least 2 kW and particularly preferably at least 3 kW, such as for example between 3.5 kW and 8 kW.

In some embodiments, a pump 31 is designed to deliver treating agent with delivery amounts of at least 5 liters/minute, preferably at least 25 liters/minute and more preferably at least 50 liters/minute, such as for example at least 80 liters/minute to 150 liters/minute or above.

In several embodiments, a pump 31 comprises, at the described delivery amounts, delivery pressures of at least 1 bar, preferably at least 3 bar, and particularly preferably at least 5 bar, such as for example between 6 bar and 10 bar.

In several embodiments, the pressure difference between an area downstream of the pump 31 to an area upstream of the pump 31 may be at least 0.5 bar, preferably at least 1 bar, more preferably at least 2 bar, such as for example between 3 bar and 5 bar.

In certain embodiments, the pump 31 may be designed as a circulation pump, wherein the pump may draw treating agent out of the process chamber 1 and then discharge it back into it, and wherein such a pump is designed such that it can permanently withstand the sometimes very high temperatures of the treating agent and preferably draws as little thermal energy as possible from the treating agent as it flows through it. Preferably, such a circulation pump may be equipped with an additional heating device and/or be very well thermally insulated, at least in the area of the fluid components. In several embodiments, the fluid lines between the process chamber 1 and a circulation pump are designed to be as short as possible, such as for example each less than 2 meters in length, preferably less than 1.5 meters and particularly preferably less than 1 meter in length.

In some embodiments, a pump 31 may convey the treating agent preferably downstream of the pump 31 into at least one additional container for receiving liquid treating agent, wherein the treating agent may be conveyed from at least one such additional container back into the process chamber 1 at least by the pressure of the pump 31. Such an additional container may be provided with an additional heating and/or cooling device and/or may be designed such that media such as for example functionalizing agents and/or granular media are contained therein and/or may be introduced therein.

The pump 31 may be designed such that it may convey in addition to the treating agent also functionalizing agents and/or granular media out of the process chamber 1 and back into it. In some embodiments, a fluid communication of the pump 31 and the process chamber 1 may be designed such that in the area in which treating agent flows back into the process chamber 1, i.e. in an area downstream of the pump 31 and at the same time in the area of the chamber wall, preferably within the chamber wall, the process chamber 1 is designed and/or forms a cavity or a type of container, such that functionalizing agents and/or granular media accumulate and/or are preferably aspirated by the Venturi principle and are subsequently accelerated by the flow of the pump 31 and distributed within the process chamber 1, wherein acceleration may take place for example by a nozzle, such as, for example, a jet nozzle, a ring nozzle, a flat nozzle or a Venturi nozzle.

In several embodiments, at least one filter unit may preferably be used upstream of at least one pump 31 such as a circulation pump, which is preferably designed for filtering suspended matter, residual powder and/or for removal of elements, excess functionalizing agent and/or granular media.

FIG. 3 shows the process chamber 1 of the apparatus 100 for carrying out the method in a third embodiment with a second process chamber 1a.

For the sake of clarity, only the process chambers 1, 1a of the apparatus 100 are shown in FIG. 3. Reference is made to the explanations with regard to the two preceding figures.

Using the exemplary arrangement of FIG. 3, the power of the apparatus 100 may be advantageously doubled by two process chambers 1, 1a. In some embodiments, for example, the reservoir 25 (see FIG. 1) may be designed as a second main chamber.

In the example of FIG. 3, the two process chambers 1, 1a are in fluid communication and existing treating liquid 5 may be pumped back and forth between the process chambers 1, 1a for the treatment process.

Thus, treating liquid 5, which is required in both the first process chamber 1 and in the second process chamber 1a, can be pumped back and forth between the two chambers by the pumps 30, 30a.

For example, while the treating liquid 5 in the first process chamber 1 is being used in a smoothing step for the polymer elements 4, the second process chamber 1a may be loaded with further polymer elements 4a. Once the smoothing step with respect to the first process chamber 1 is completed, the treating liquid can be pumped out of it and into the second process chamber 1a via the pump 30. The smoothing of the polymer elements 4a may then begin in the second process chamber 1a, while the polymer elements 4 of the first process chamber 1 are removed from it and the first process chamber 1 is then loaded with new polymer elements 4. After completion of the smoothing step of the polymer elements 4a, the treating liquid 5 may be conveyed back into the first process chamber 1 by the pump 30a so that the next smoothing step can be carried out there, etc.

This arrangement is purely exemplary and is not to be understood as limiting. Optionally, in certain embodiments, only one line may be provided between the process chambers 1, 1a with a pump that can convey in both directions.

By providing several process chambers, the power of such an apparatus 100 may thus be multiplied.

FIG. 4 shows schematically simplified the course of a method according to the present invention in an embodiment.

Reference is made to the reference numerals of FIG. 1 to FIG. 3.

Step S1 represents providing a treating liquid in a chamber 1 of an apparatus 100.

Step S2 represents providing the polymer elements to be treated.

An optional heating step for heating the treating liquid to a temperature below an upper threshold temperature is represented by step a). Thereby, the upper threshold temperature is, for example, in a range from about 1° C. to about 150° C. below the melting temperature of the polymer from which the polymer elements are formed.

Step b) represents a treatment step, here exemplarily a smoothing step. In this, the polymer elements are in, or come into, contact with the treating liquid at a temperature preferably above a lower threshold temperature and below the upper threshold temperature for a predetermined period. Conditions prevail in which the treating liquid is in liquid state.

Step c) represents an optional cooling step for cooling the polymer elements.

### LIST OF REFERENCE NUMERALS

1, 1a process chamber
2, 2a cover
3, 3a inner container
4, 4a polymer elements
5 treating liquid
6, 6a process vapor; process gas
7, 7a circulation device
8 heating device
9 cooling line; cooling surface; cooling device
10 coolant tank
11 pump
12 tank for process gas
13 pressure relief valve
14 control device or closed-loop control device
18 gas valve
16 valve for treating liquid
17 valve for functionalization liquid or component cooling liquid
18 pump
19 pump
20 coolant tank
21, 21a container for functionalization liquid or component cooling liquid; color tank
22 coolant
23 functionalization of liquid coolant or of component coolant
24 vacuum pump
25 reservoir for treating liquid
26 temperature sensors and pressure sensors
27 heating device in the reservoir
30, 30a pump
31 pump (e.g. circulating pump)
100 apparatus

1. A method for treating polymer elements which were obtained by an additive manufacturing process, the method encompassing
providing a treating liquid in a chamber of an apparatus;
providing the polymer elements to be treated;
further encompassing the steps of
a) optionally: a heating step for heating the treating liquid to a temperature below an upper threshold temperature, wherein the upper threshold temperature is in a range of 1° C. to 150° C. below the melting temperature of the polymer from which the polymer elements are formed;
b) a treatment step, wherein the polymer elements are in, or come into, contact with the treating liquid at a temperature which is below the upper threshold temperature for a predetermined period or a minimum period, under conditions in which the treating liquid is in liquid state, and
c) optionally: a cooling step for cooling the polymer elements.

2. The method according to claim 1, wherein the treating liquid comprises water and at least one alcohol, wherein the weight ratio of the water to this alcohol is in a range from 99:1 to 1:99.

3. The method according to claim 1, wherein granular media are present in the treating liquid or are in, or are brought into, contact with the treating liquid.

4. (canceled)

5. The method according to claim 3, wherein during treatment step b) at least temporarily mixing of the treating liquid with the polymer elements and the granular media is ensured or provided.

6. The method according to claim 5, wherein the mixing takes place in the form of an annular flow and/or upward flow and/or vibration, sound or ultrasound and/or other forms such as pressure changes.

7. The method according to claim 1, wherein treating agents and/or functionalizing agents and/or granular media are conveyed out of the process chamber and back into it by a pump.

8. (canceled)

9. (canceled)

10. (canceled)

11. (canceled)

12. (canceled)

13. The method according to claim 1, wherein prior to treatment step b) the polymer elements are held in an upper section of the chamber in which section treatment step b) is or will be carried out, and which is filled with gas, e.g. at normal pressure, below or above, in a step of applying vapor for a predetermined minimum duration.

14. (canceled)

15. (canceled)

16. (canceled)

17. (canceled)

18. (canceled)

19. The method according to claim 1, wherein the treating liquid is or comprises propylene glycol, with or without added water.

20. (canceled)

21. The method according to claim 1, wherein
the polymer elements to be treated are present in the treating liquid and are in contact with it during heating, or
the heating step a) encompasses that the treating liquid is heated at least to the lower threshold temperature, up to the upper threshold temperature or beyond, and that the polymer elements are heated separately in an aqueous solution and/or aqueous vapor to a temperature below the upper threshold temperature, and wherein in, or for, the treatment step b) the treating liquid and the polymer elements are brought into contact with each other for treatment.

22. The method according to claim 1, wherein in at least one step at least one functionalizing agent is applied to the polymer elements during or after the treatment with the treating liquid.

23. The method according to claim 22, wherein at least one functionalizing agent is applied during or after step c), wherein the method further encompasses a step d) for functionalizing the treated polymer elements (4) by applying at least one functionalizing agent.

24. The method according to claim 1, wherein during at least one of steps a) to c) and/or during the functionalization step d) devices for driving the treating liquid and/or the functionalization agent are used.

25. The method according to claim 2, wherein the functionalizing agent comprises at least one agent selected from a colorant, a dye, a pigment, a fiber, a hardening agent, a metal powder, a polymer powder, an inorganic pigment or powder, a hydroxyapatite, a calcium phosphate, a bioactive ceramic, an electrostatic discharge agent, a filler, a textile fiber, a base, an acid, a buffer solution, a finishing agent and/or a plasticizer.

26. The method according to claim 22, wherein in the functionalization step d) a colorant or a colorant solution is applied.

27. (canceled)

28. The method according to claim 1, wherein treatment step b) is a smoothing step.

29. An apparatus for treating polymer elements obtained by an additive manufacturing process, comprising a chamber with a cover, at least one container for receiving the polymer elements and the treating liquid and devices for temperature control prepared for carrying out the method according to claim 1.

30. The apparatus according to claim 29, further comprising a pump for circulating the treating agent.

31. The apparatus according to claim 29, prepared for carrying out the method.

32. (canceled)

33. The apparatus according to claim 32, wherein the container for additives comprises colorants, pigments, functionalizing agents, granular media and/or additives.

34. The apparatus according to claim 29, wherein a reservoir with warmer or colder treating liquid than the treating liquid in the chamber is in fluid communication with the chamber.

35. The apparatus according to claim 34, wherein the fluid communication is in functional connection with a circulating pump and/or a device for pressurization.

36. The apparatus according to claim 29, wherein a mechanical duct or a magnet duct is provided for moving the inner container, in particular for its rotation and/or its up/down movement.
